(19) United States
(12) Patent Application Publication
(10) Pub. No.: US 2005/0151941 A1
(43) Pub. Date: Jul. 14, 2005

(54) Advanced performance widget display system

(76) Inventor: Dennis J. Solomon, Yarmouth Port, MA (US)

Correspondence Address: Dennis J. Solomon, P.O. Box 289, Yarmouth Port, MA, 02675, US

(21) Appl. No.: 10/941,461

(22) Filed: Sep. 15, 2004

Related U.S. Application Data
(63) Continuation-in-part of application No. 09/793,811, filed on Feb. 24, 2001, now abandoned.
(63) Continuation-in-part of application No. 10/385,349, filed on Mar. 10, 2003, now abandoned.
(63) Continuation-in-part of application No. 10/307,620, filed on Dec. 2, 2002.
(60) Provisional application No. 60/212,315, filed on Jun. 16, 2000.

(51) Int. Cl. G03B 21/00

(52) U.S. Cl. 353/122

(57) ABSTRACT

A simplified performance wand display system with an illuminated wand display and having other modalities such as audio and tactile is disclosed. The display utilizes the persistence of vision approach and presents a series of dynamic images and text on each cycle. Programming images and sounds may be controlled by external sources including projectors and Internet displays. Each wand may be assigned an identity at performance time based on its current location. A strategy and physical game model is presented. Applications include promotions, toys, games, gifts and related novelties.

This present application claims the benefit of provisional patent application 60/212,315, 60/212,315 and is a continuation-in-part of U.S. patent application Ser. Nos. 09/793,811, 10/385,349 and 10/307,620 which are incorporated herein by reference. The integration of the technologies in a performance wand display system is described in coherent Sections I, II, III, IV having repetitive figure numbering and object numbering.

### TECHNICAL FIELD

This invention relates generally to display devices and more particularly to autostereoscopic imaging displays.

### BACKGROUND ART

The participation of the audience as an active part of a computerized special effect has never been perfected and the concept itself is a recent phenomenon. A few inventions have been proposed which have generally been too complicated to be reliable, expensive to manufacture, without sufficient resolution, or sufficient stability to gain any acceptance. None have combined a directional projector and an active, responsive display wand in the control of each member of the audience.

In contrast, the presentation of visual images by moving display elements has a long and crowded history. Following the development of light emitting diodes (LEDs), a large variety of displays, games, wands and yo-yos have been manufactured, publicly presented and patented. These inventions strobe arrays of individual light elements or pixels as the array is displaced cyclically, producing an image or pattern due to the persistence phenomenon of human vision. Francis Duffy in his U.S. Pat. No. 3,958,235 discloses linear wand of LEDs oscillated by a door buzzer electromagnetic actuator. He specifically indicated that a manual actuator may be used. Edwin Berlin in his U.S. Pat. No. 4,160,973 extended the work of Duffy to both 2D & 3D devices using “rotational” or “short-distance oscillatory motion” with extensions of Nipkow's disc television. Berlin also disclosed the use of moving digital memory and electronics and a “single pulse (per cycle) which adjusts the frequency of a clock (controlling the timing of each LED)”. Bill Bell is his U.S. Pat. No. 4,470,044 disclosed a single stationary array of LEDs with “saccadic eye movement” timing with non-claimed references to applications including wands, tops and bicycles.

Marhan Reysman in his U.S. Pat. No. 4,552,542 discloses a spinning disc toy with a centrifugal switch causing a light to be illuminated. It follows a line of inventions related to tops and yo-yos. Hiner is his U.S. Pat. No. 4,080,753 discloses a toy flying saucer with a centrifugal motion sensor.

The techniques of Duffy, Berlin & Bell were applied to handheld wands differentiated from the prior art by the detailed centrifugal switch design. Tokimoto is his U.S. Pat. No. 5,406,300 discloses a display wand with a Hall effect acceleration sensor. Sako in his U.S. Pat. No. 5,444,456 uses an inertial sensor having “a pair of fixed contacts and a moveable contact” to adjust the clock of the display electronics. While inventive and functional, the Sako design remains awkward and requires considerable energy to maintain an image. For these reasons, it is unsuitable for entertainment, marketing and game applications.

At many events from the mid-1980s, these and simpler visual and audio producing items have been combined with non-directional, wireless signals to produce a global special effects. As disclosed in Bell's U.S. Pat. No. 4,470,044, these technologies may be affixed to bicycles and motorized vehicles, to clothing, wands, yo-yos and other accessories.

Additionally, wireless technologies have been applied to visual and audio producing proximity devices such as dance floors—U.S. Pat. No. 5,558,654, pagers—U.S. Pat. No. 3,865,001, top hats—U.S. Pat. No. 3,749,810, and clothing—U.S. Pat. No. 5,461,188 to produce a global synchrony and pre-programmed or transferred effects.

None of these or the other prior art has successfully addressed the problem of providing low cost, real-time, precision control of audio or visual effects such that an affordable uniform appliance distributed, affixed, attached, accompanying or held by each member of an audience or group would seamlessly, and without error, integrate in a global screen or orchestra in real-time.

A number of other problems have remained including the development of switching methodology which permits a static on-off state, display freedom from inertial changes and a frame of reference to global orientation.

This inventor has a long history of invention in these relative fields of persistence of vision, three dimensional and professional stage, film and event special effects. His U.S. Pat. No. 4,983,031 (1990) discloses a method of data display control and method for the proper display of images to all observers in both directions for projection and LED moving displays—technologies chosen by the U.S. Department of Defense for advanced airspace control. His U.S. Pat. No. 4,777,568 (1988) and U.S. Pat. No. 4,729,071 (1987) disclose a high speed, low inertial stage scanning system—currently in use by major international touring music and theatre acts. In part, both are related precursors to the present invention.

### SUMMARY OF THE INVENTION

The present invention discloses an improved method and device for the low cost, real-time, precision control of audio or visual effects such that an affordable uniform appliance distributed, affixed, attached, accompanying or held by each member of an audience or group would seamlessly, and without error, integrate in a global screen or orchestra in real-time.

Additionally, an object of the invention is an improved motion switching method for the display wand including a frame of reference to global orientation.

Another object of the invention is a reduction in the cost and energy required to operate the performance display wand system.

A further object is the application of the method of the present invention to promotional and entertainment devices and games.

Another object is the application of the method to artistic presentations,

Another object is the application of the method to autostereoscopic presentations,

Another object of this invention to provide a game method that enhances hand-eye coordination and other skills,

The above and still further objects, features and advantages of the present invention will become apparent upon consideration of the following detailed disclosure of specific embodiments of the invention, especially when taken in conjunction with the accompanying drawings, wherein:

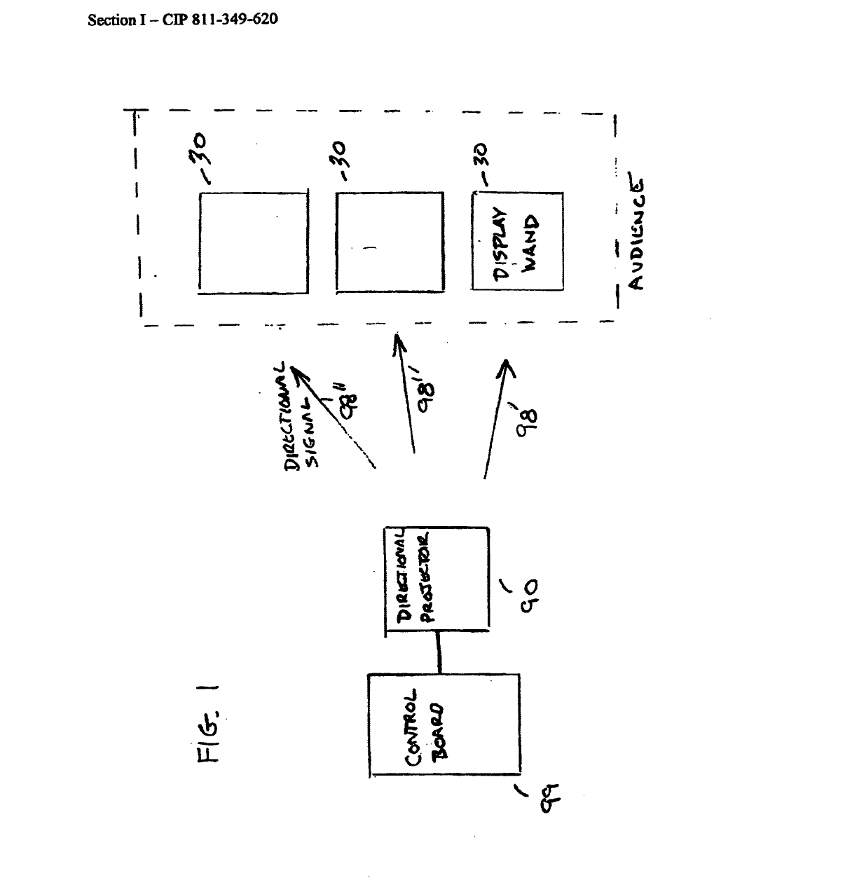

FIG. 1 presents a block diagram of the performance wand display system.

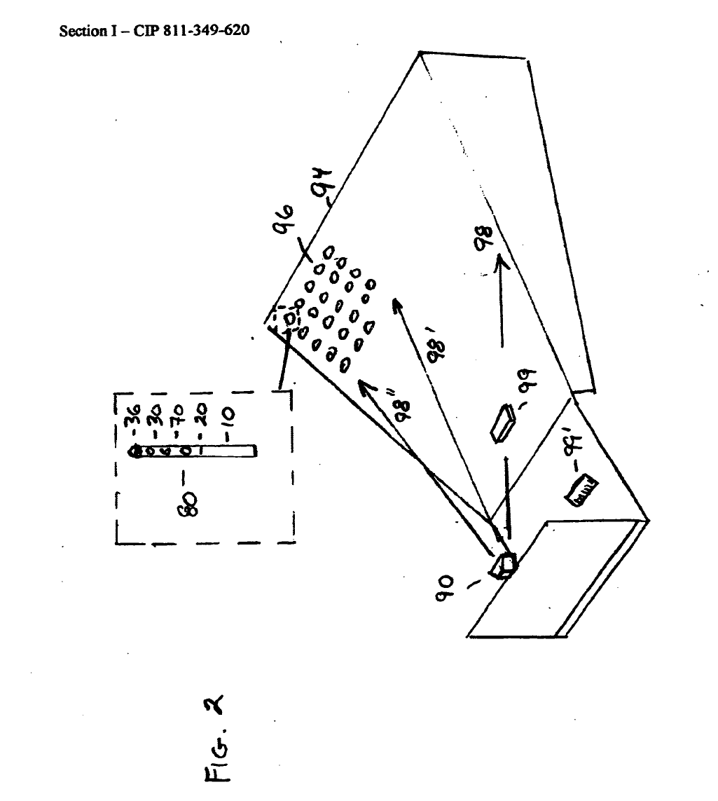

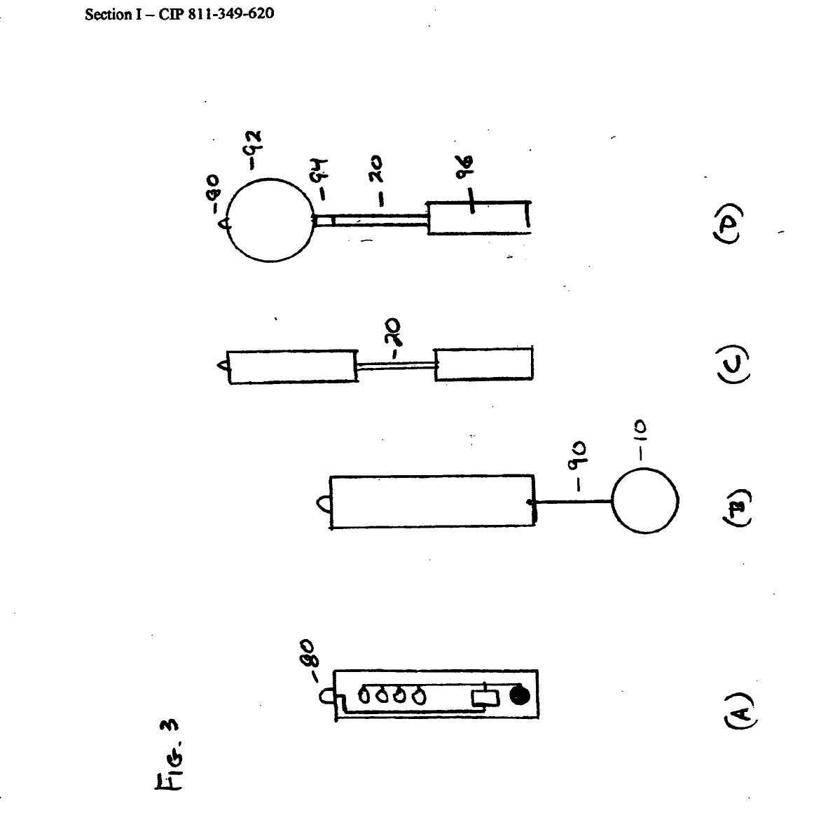

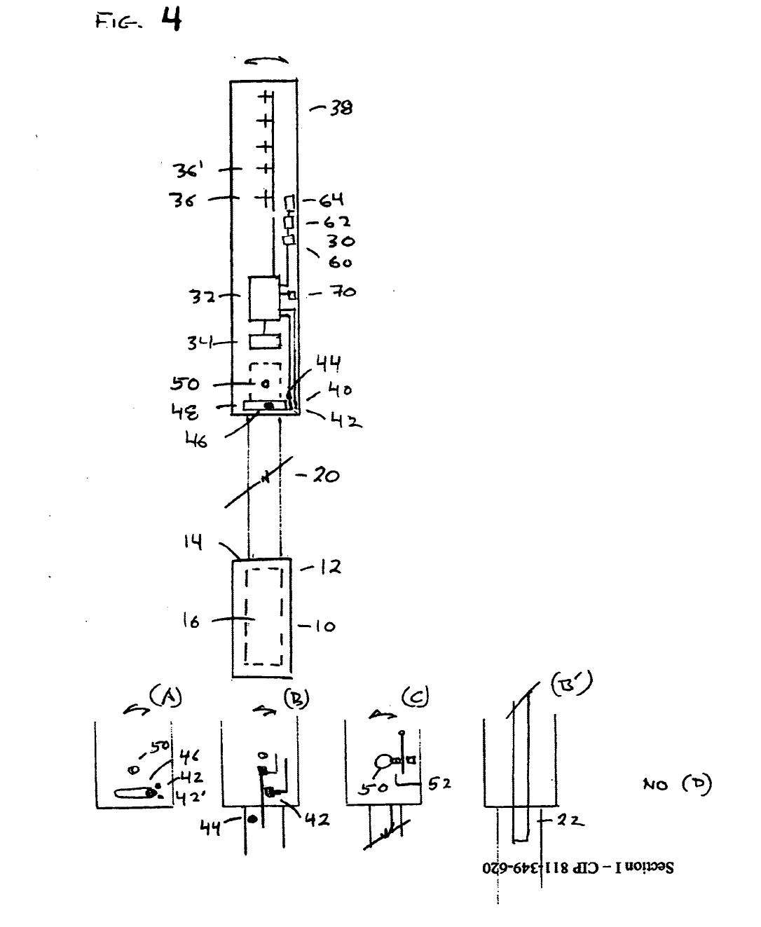

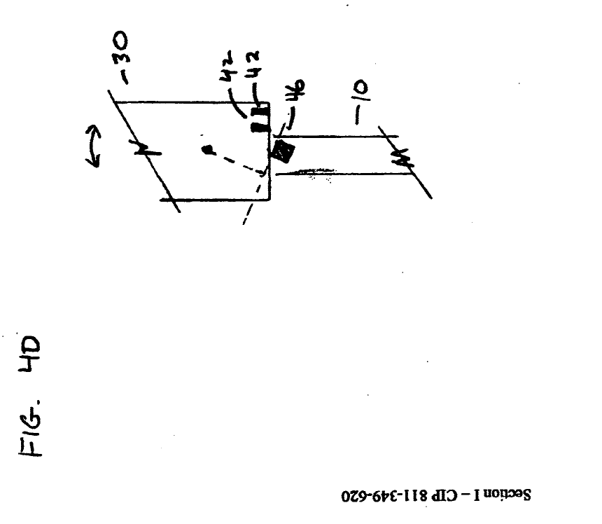

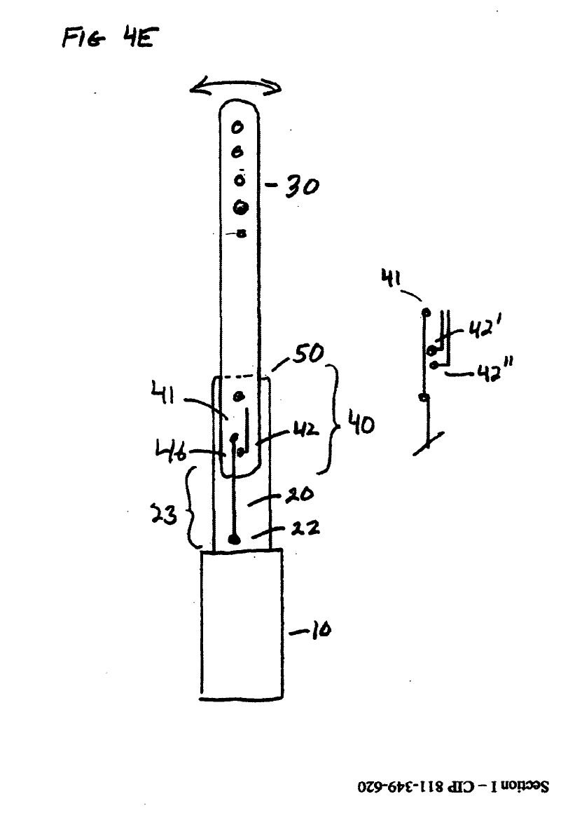

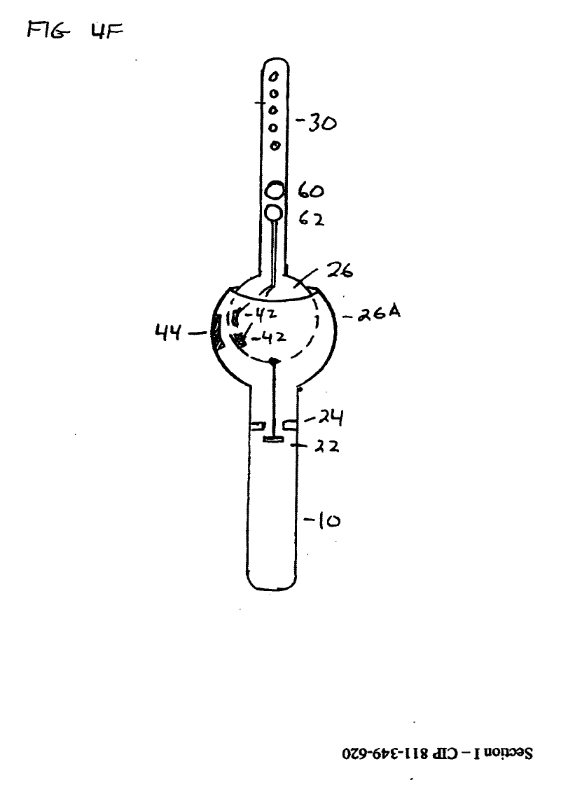

FIG. 2 presents a perspective view of the performance wand display system.

FIG. 3 presents a cross section of a simplified performance display wand.

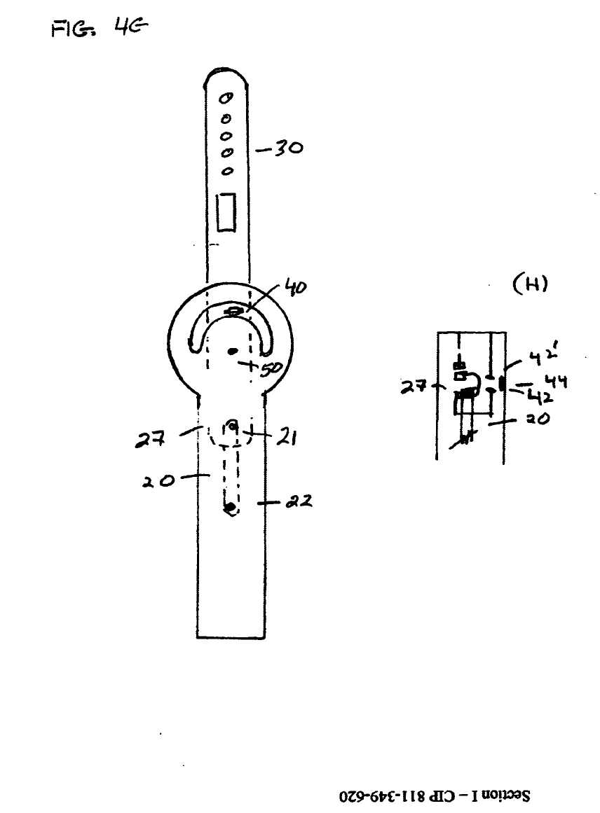

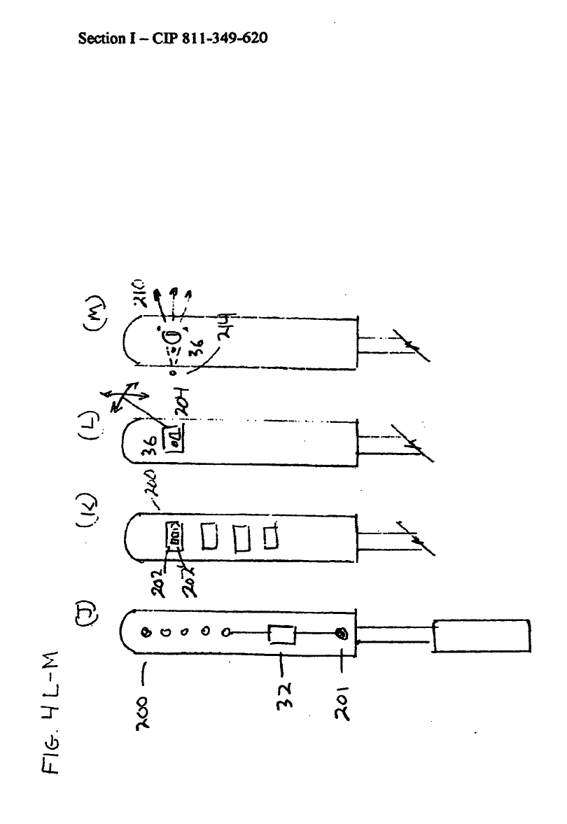

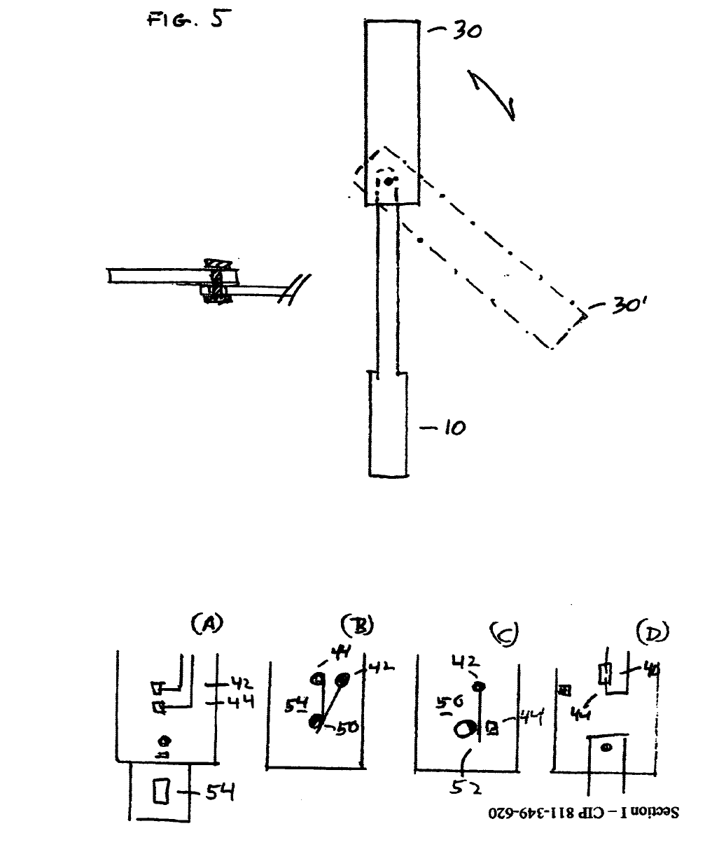

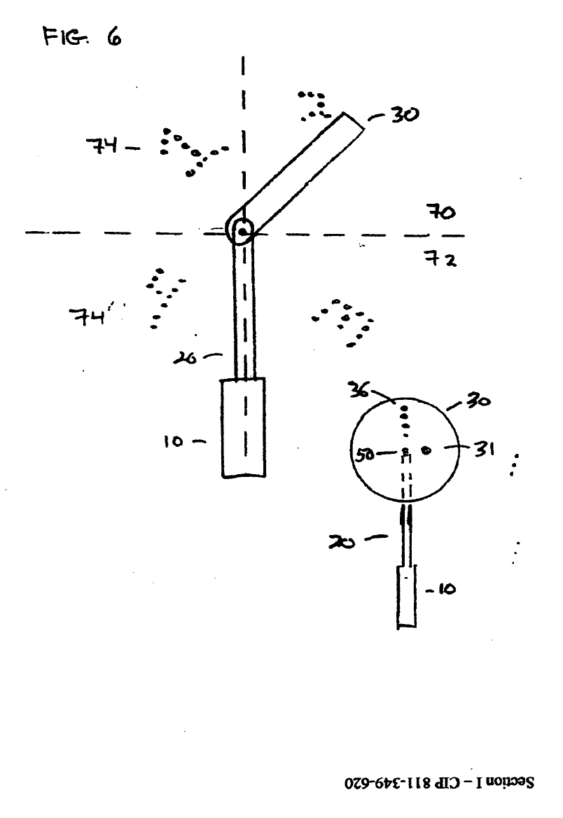

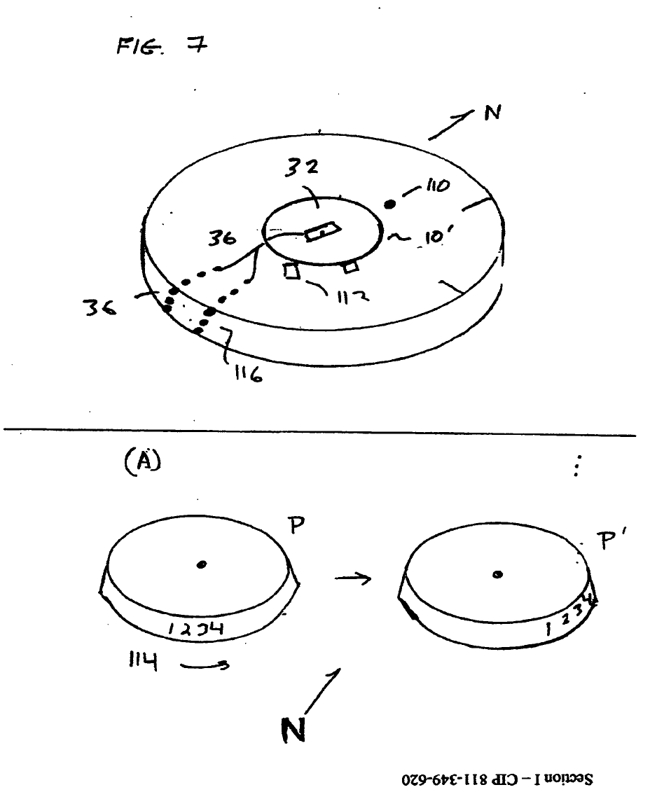

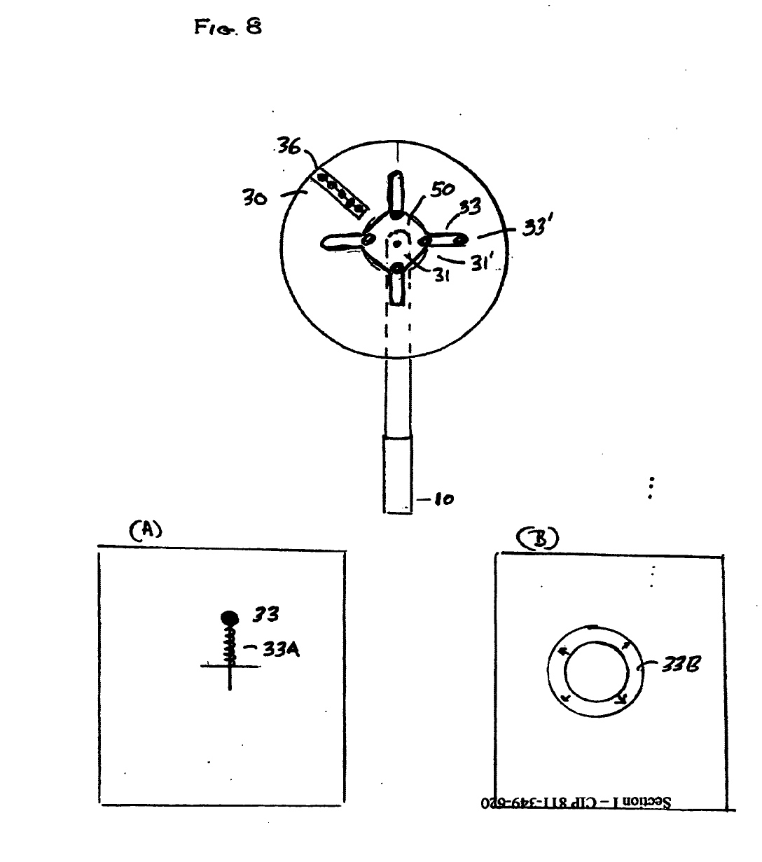

FIGS. 4a-m presents the different motion switch constructions of the display wand.

FIG. 4I is omitted.

FIG. 5 presents a cross section of a rotating embodiment of the advanced display wand.

FIGS. 5a-d presents switch constructions of the display wand.

FIG. 6 presents a programming result of the display wand.

FIG. 7 presents a flying disk embodiment of the display wand.

FIG. 8 presents a centrifugal energy storage system of the display wand.

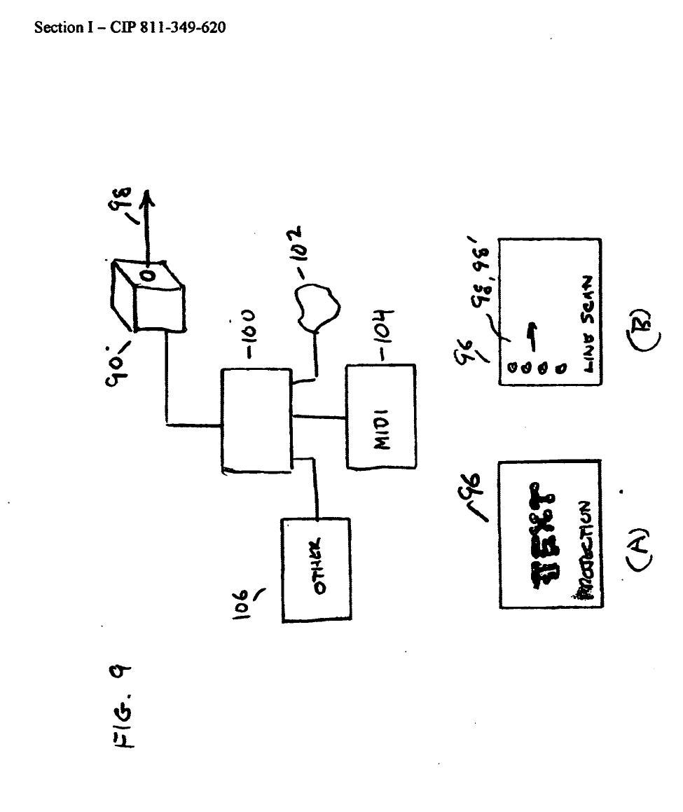

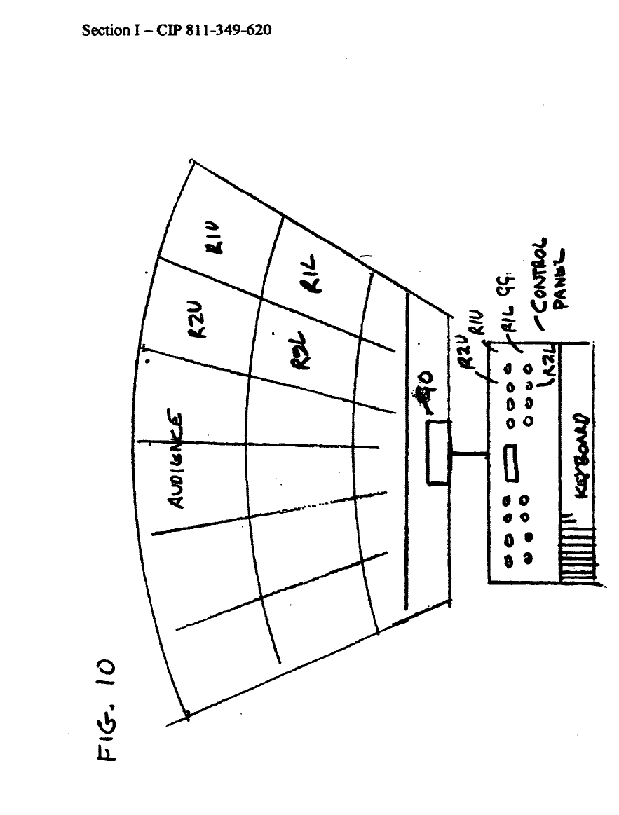

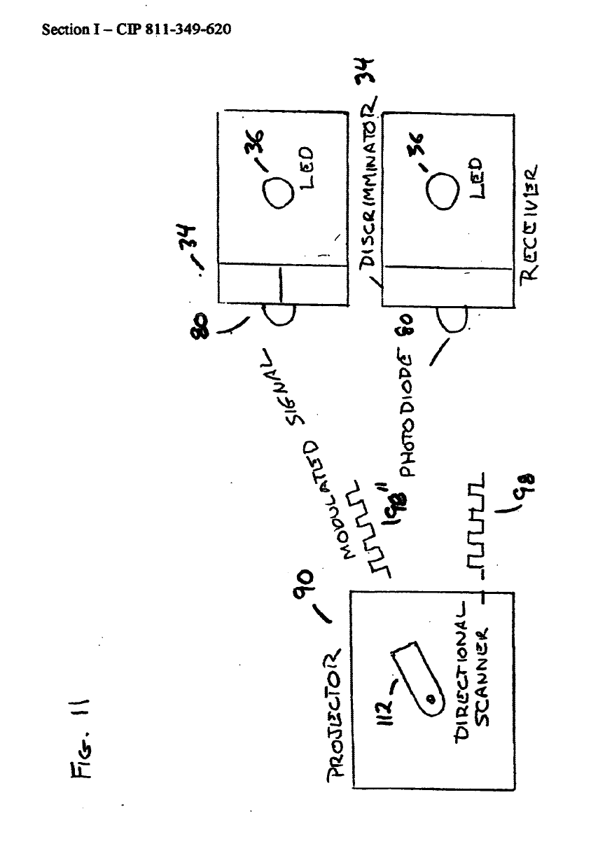

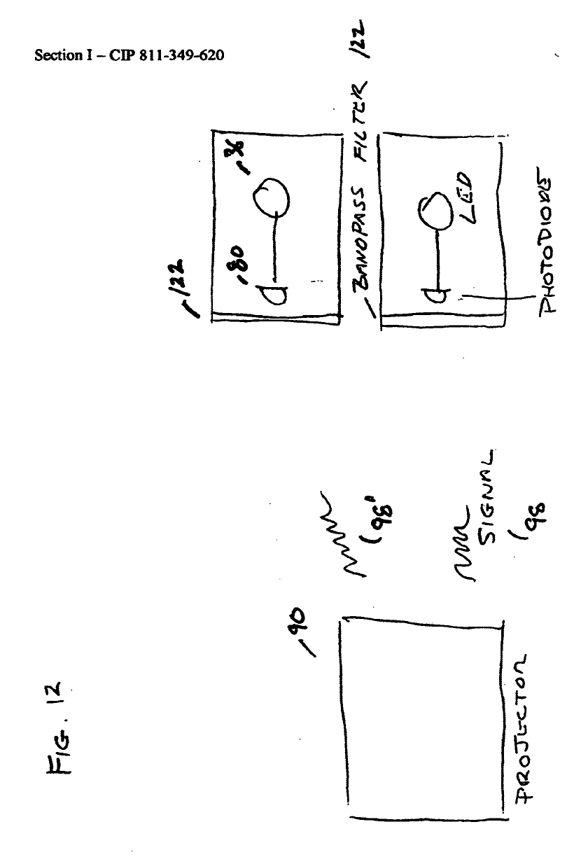

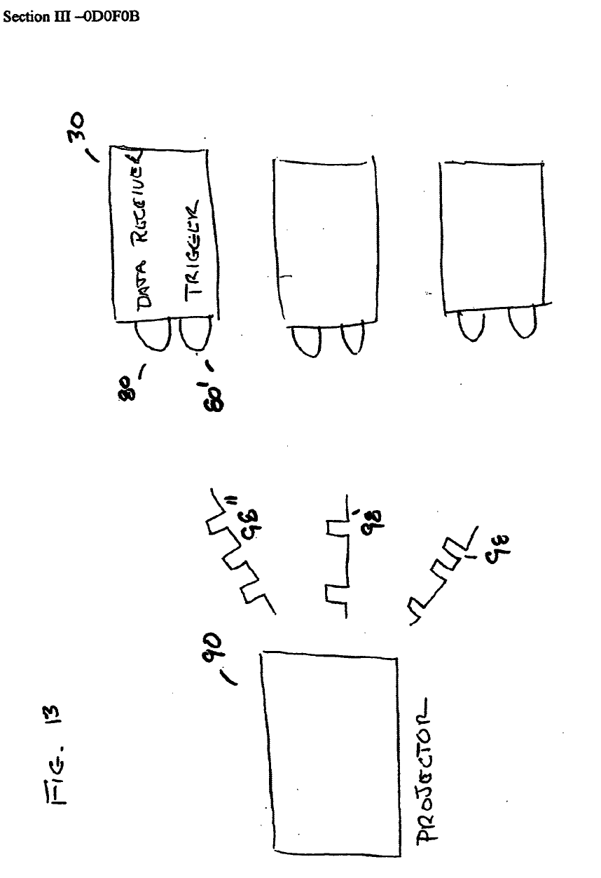

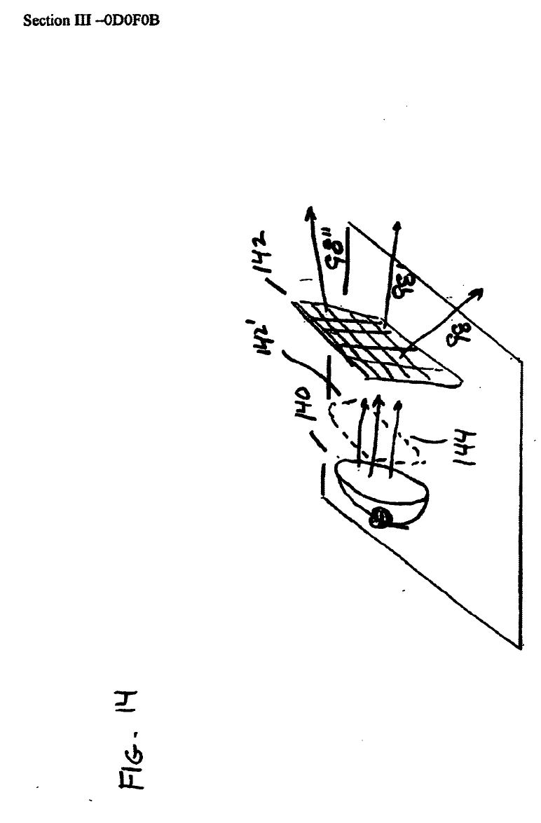

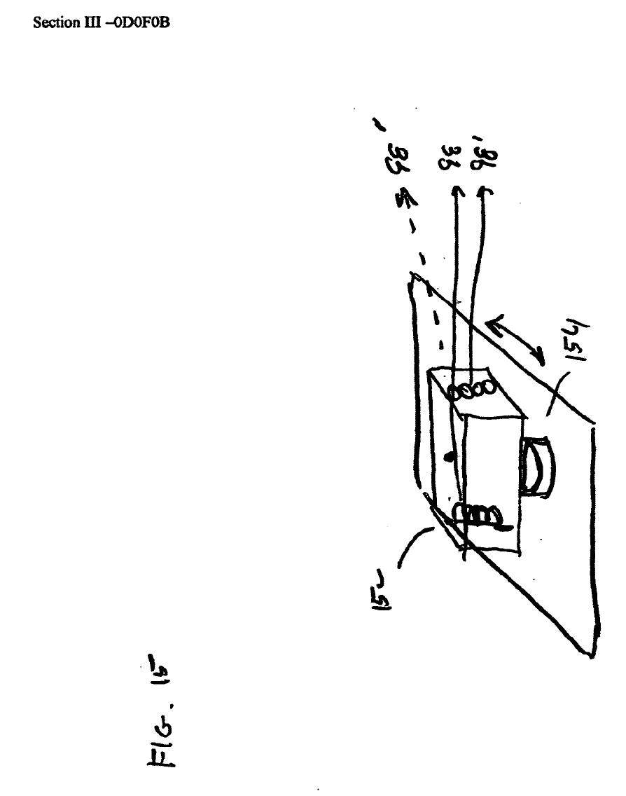

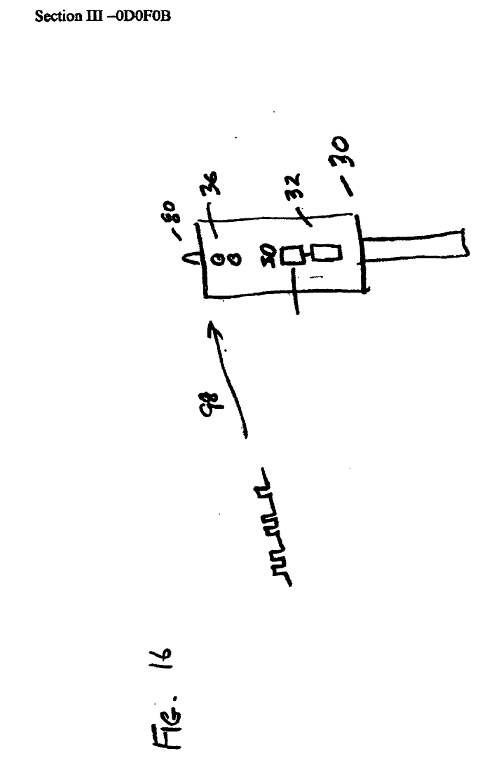

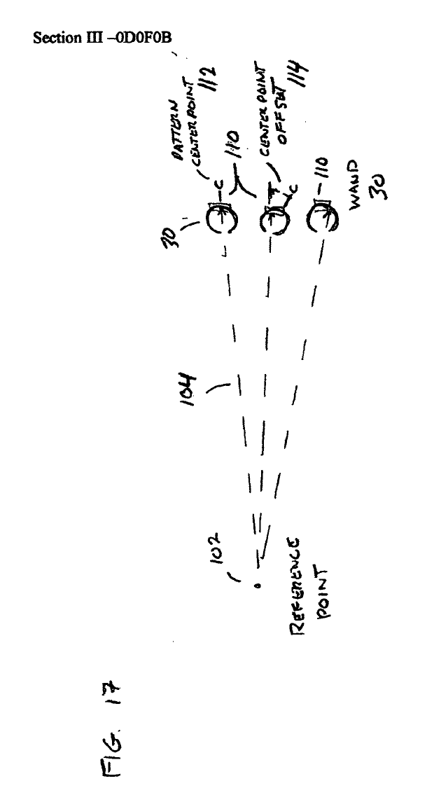

FIG. 9 presents a conceptual structure the projector of the system.

FIG. 10 presents a conceptual structure the keyboard controller of the system.

FIG. 11 presents a partial schematic diagram of projector—receiver trigger system—modulated.

FIG. 12 presents a partial schematic diagram of projector—receiver trigger system—chromatic.

FIG. 13 presents a block diagram of projector—receiver ID trigger system.

FIG. 14 presents a perspective view of an image projector.

FIG. 15 presents a perspective view of a scanning projector.

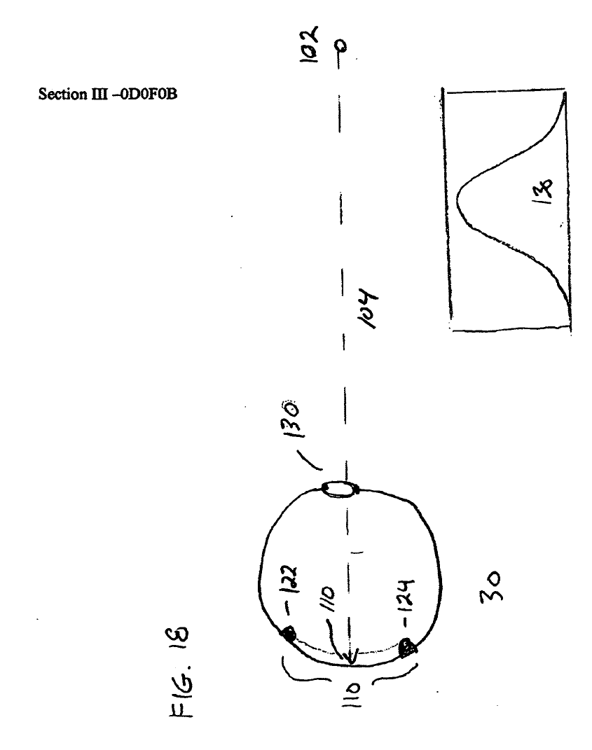

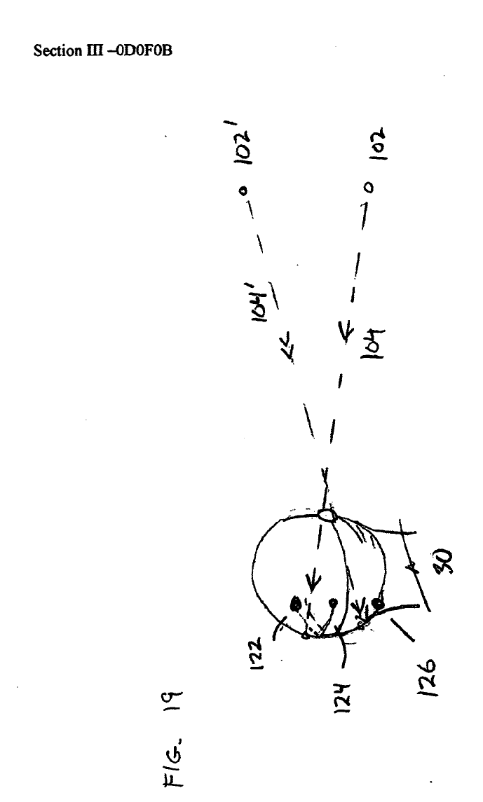

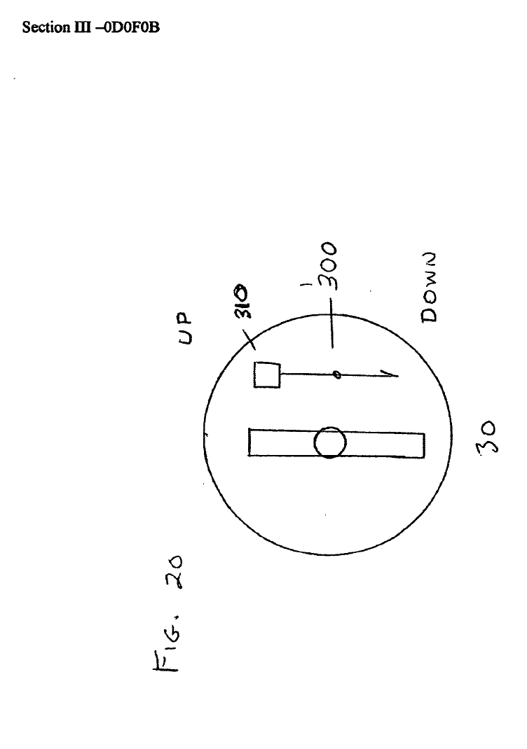

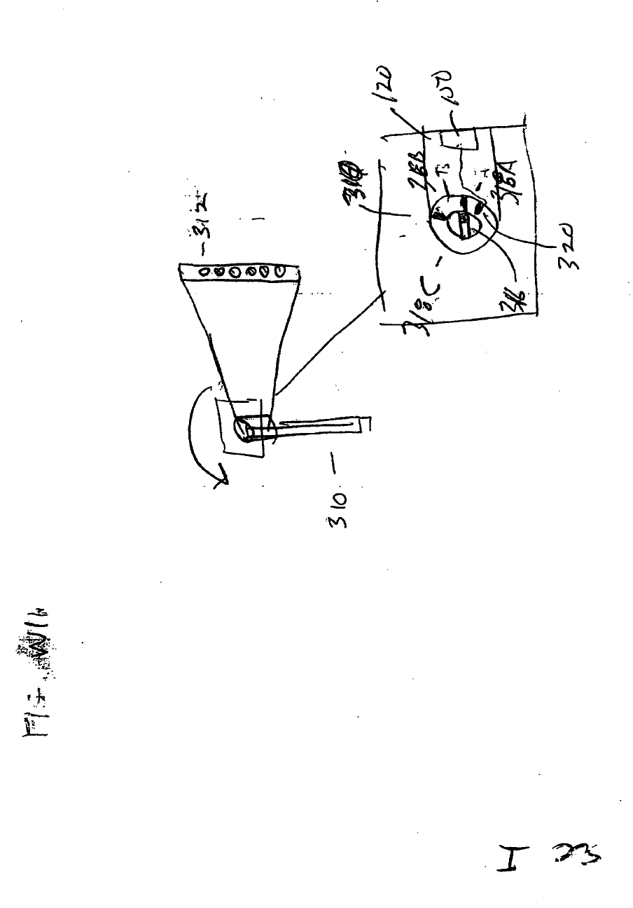

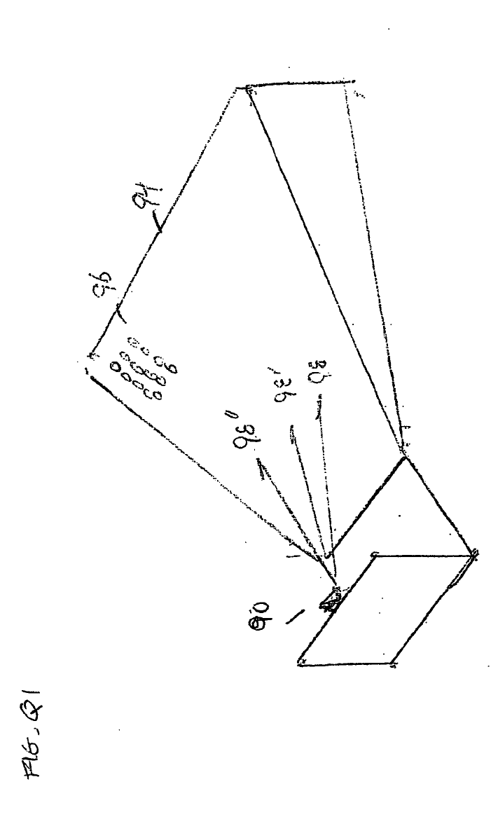

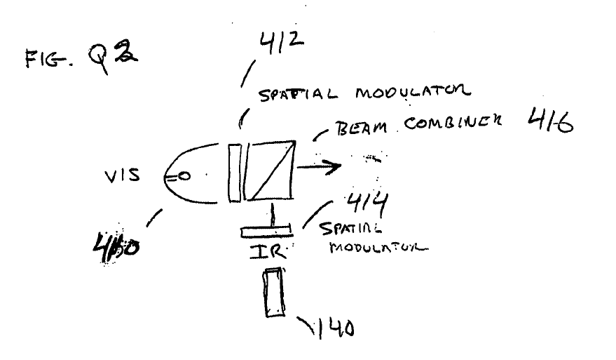

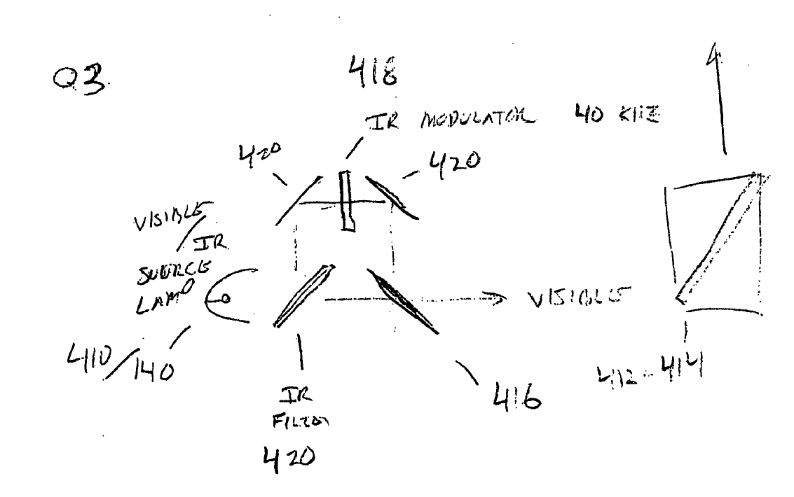

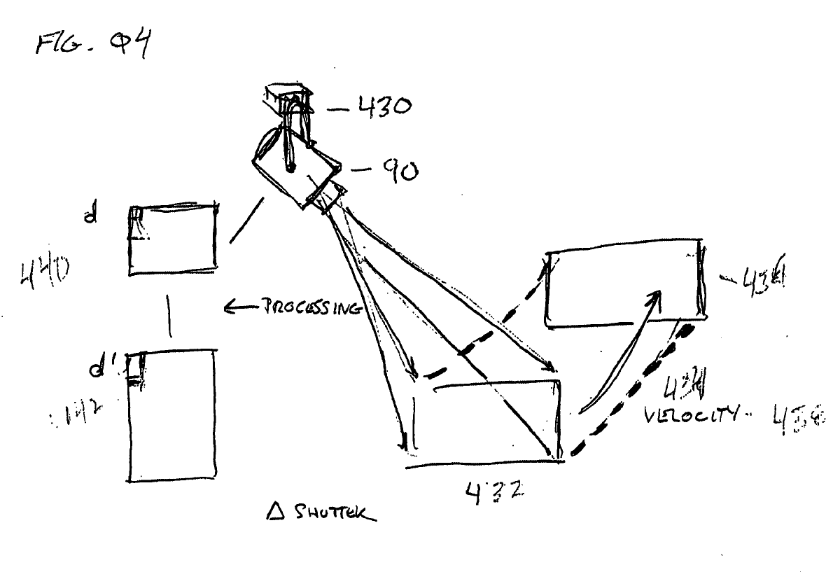

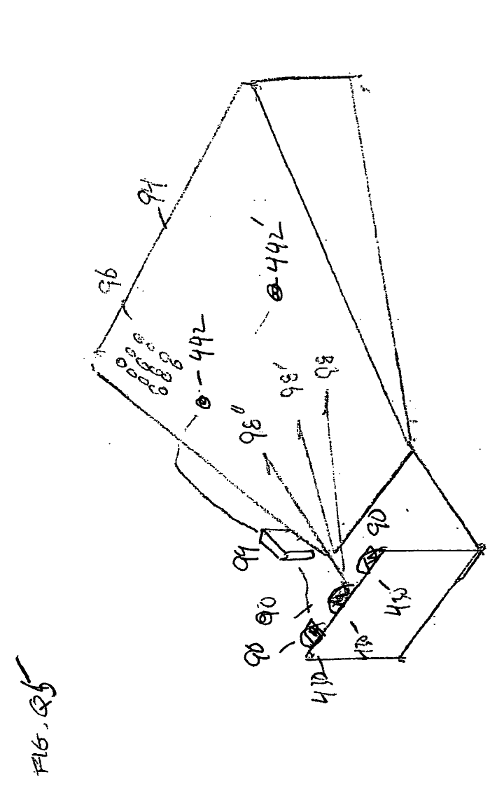

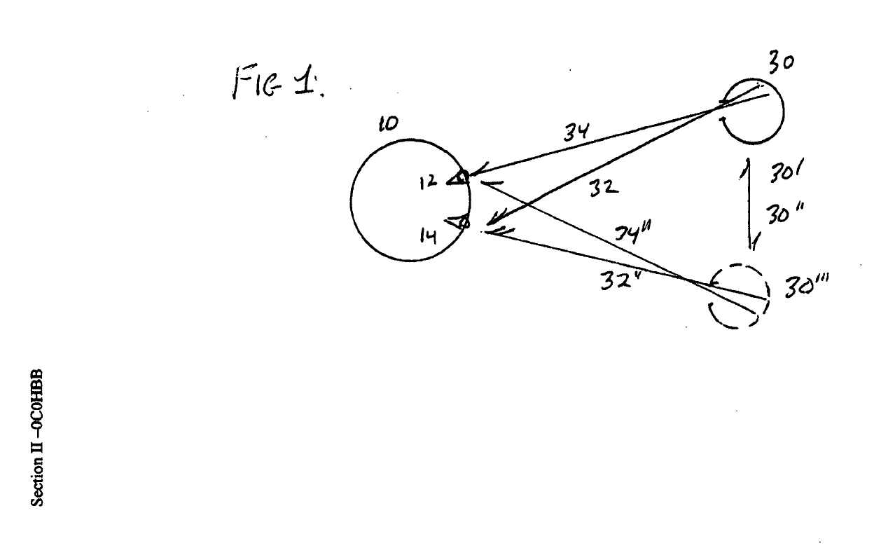

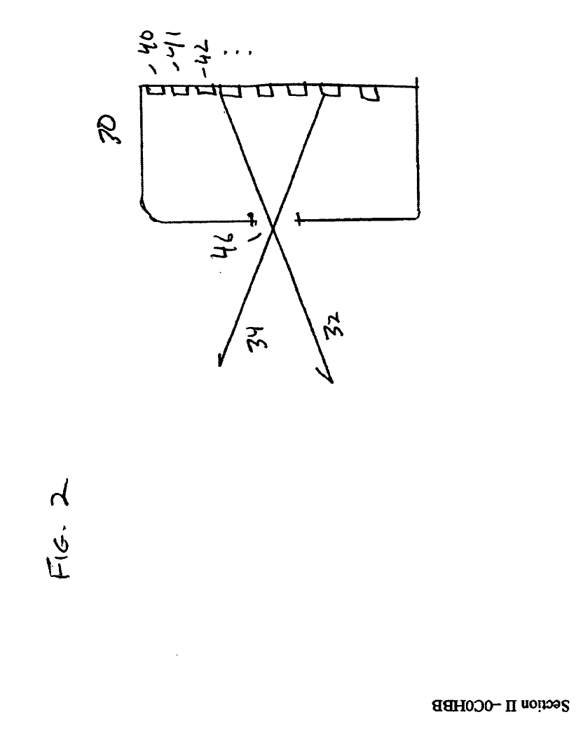

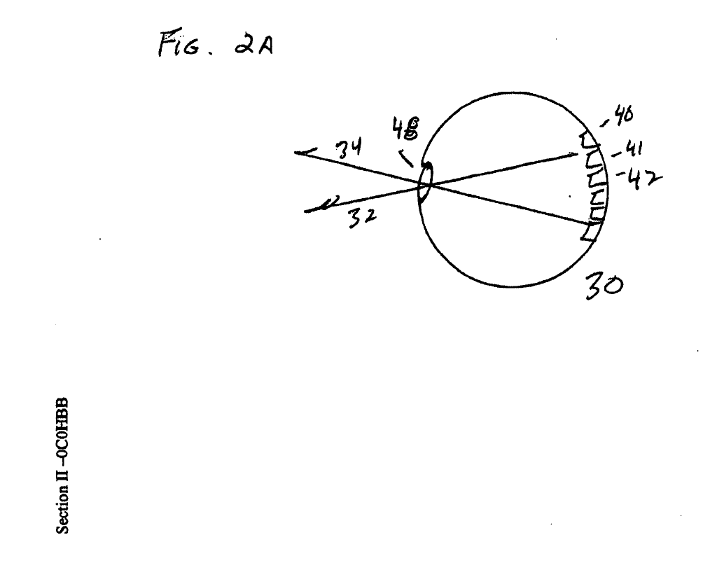

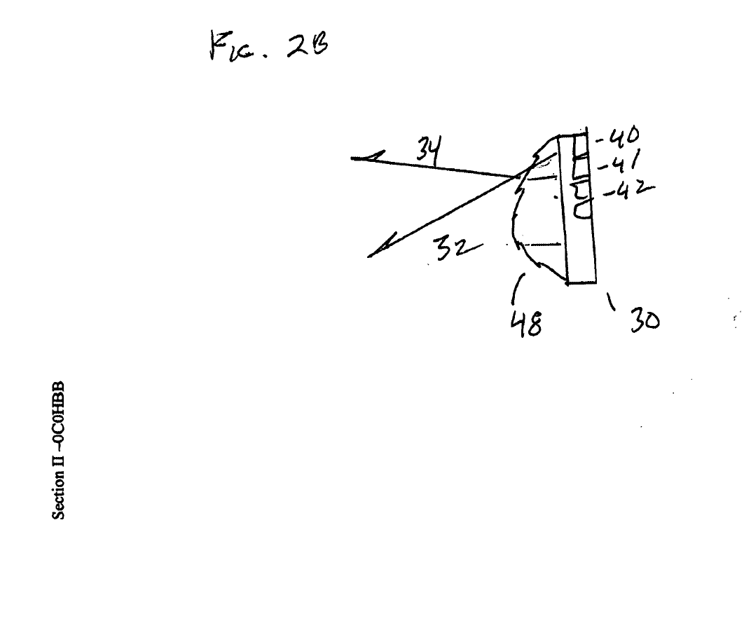

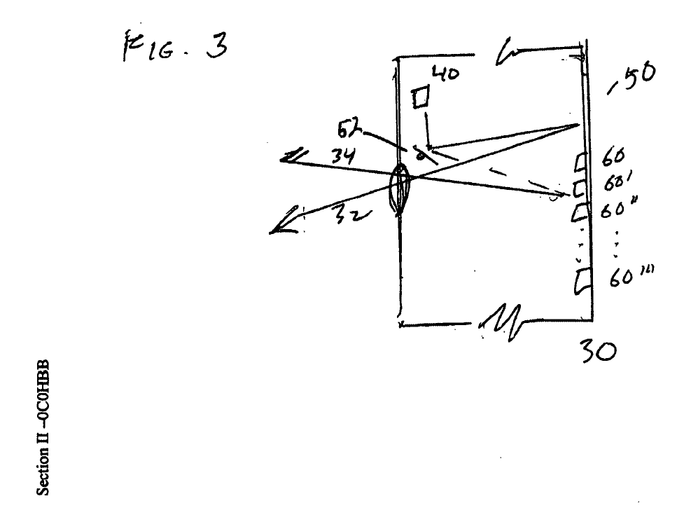

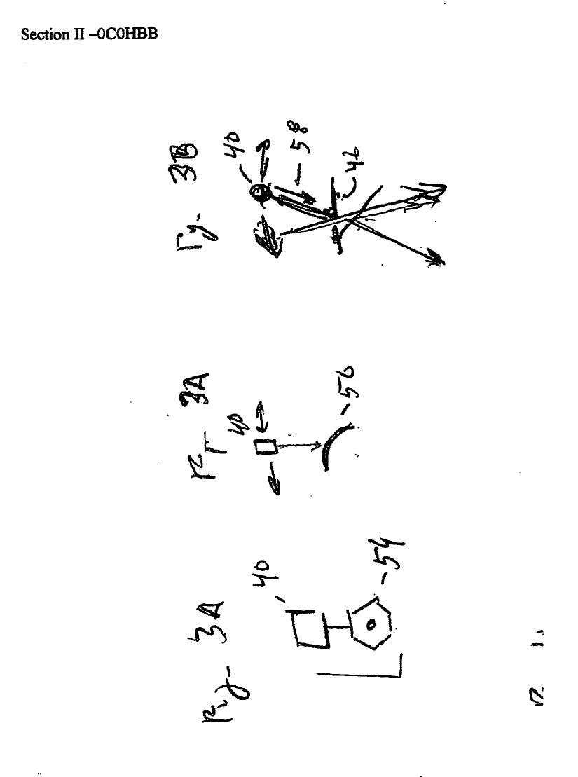

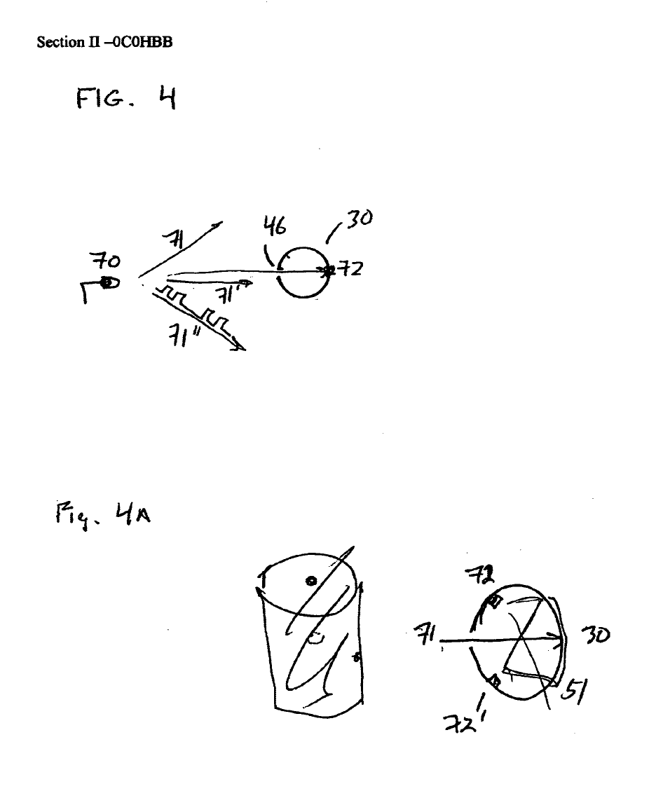

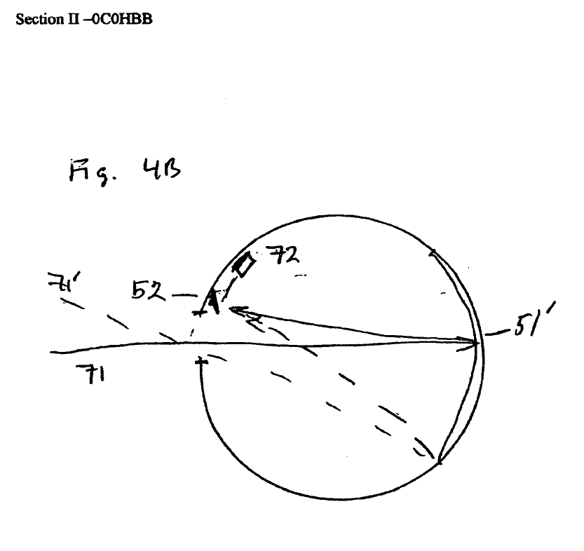

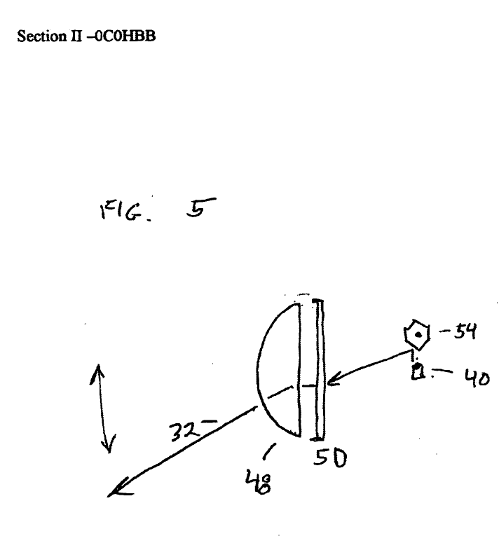

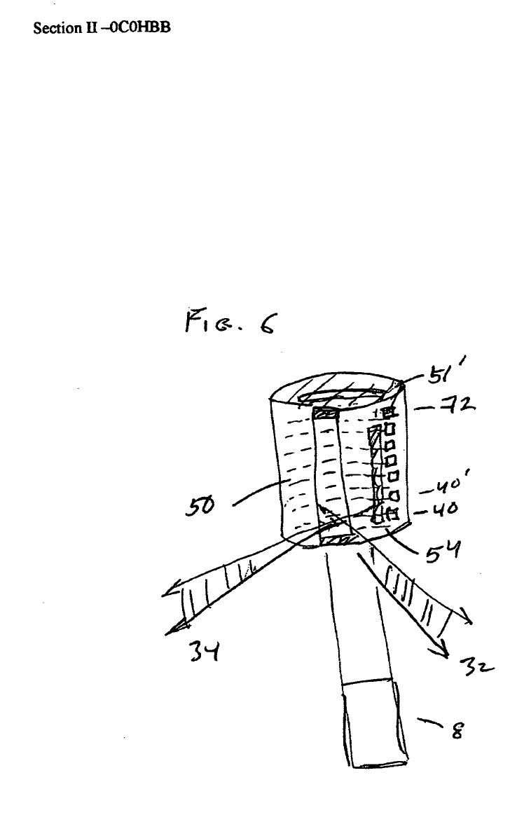

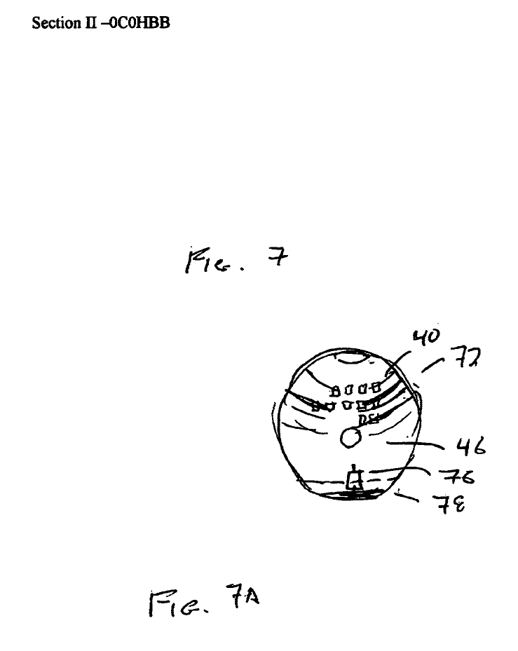

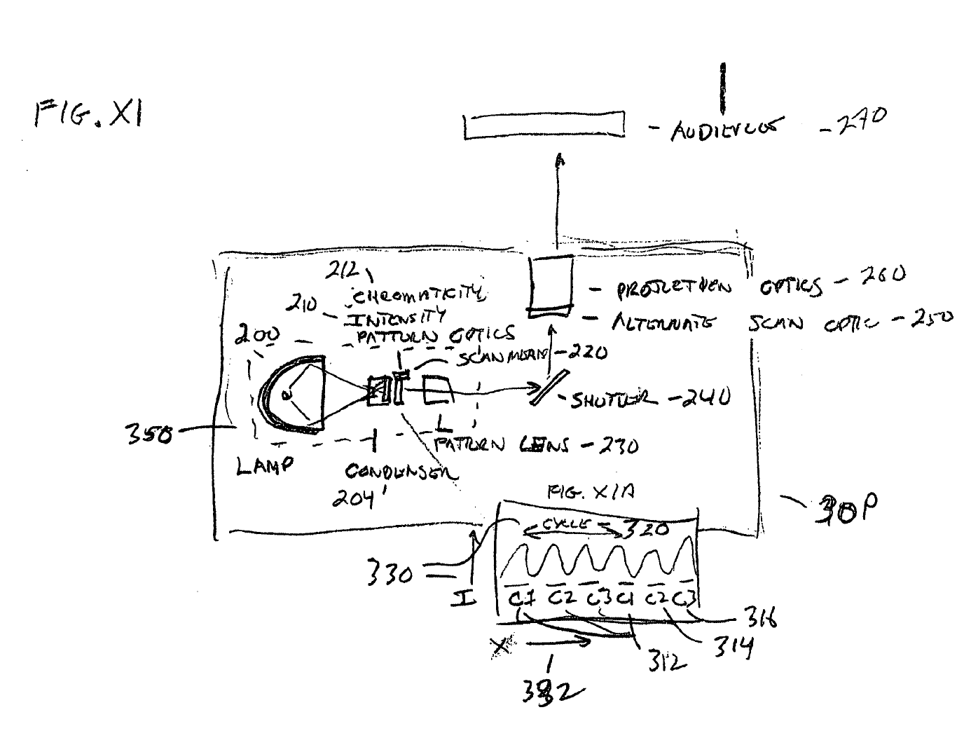

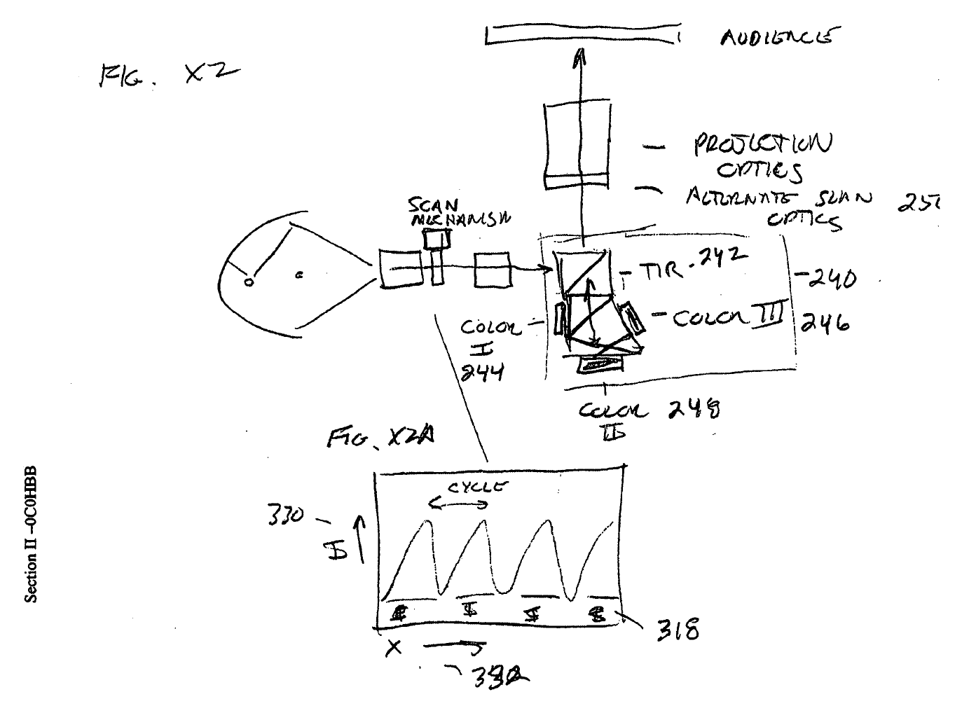

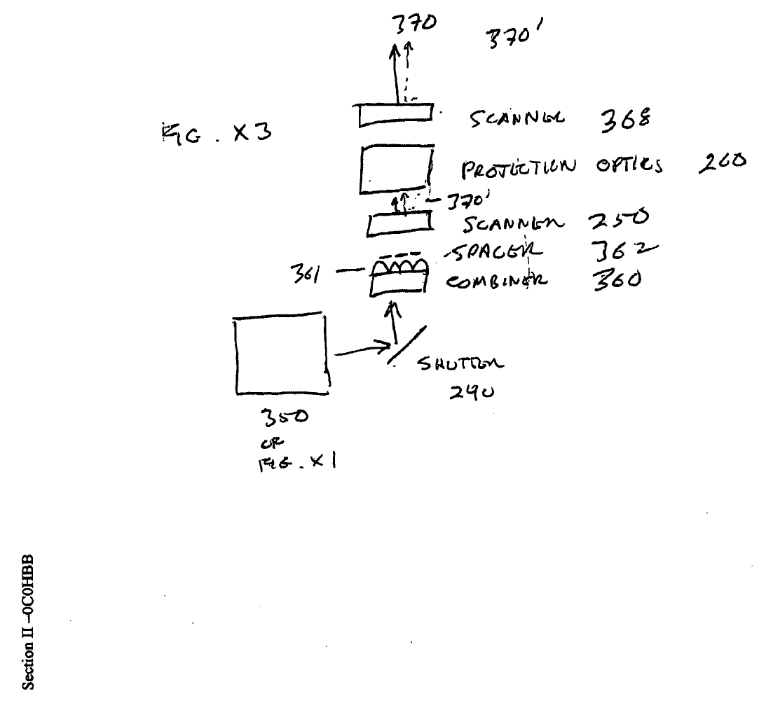

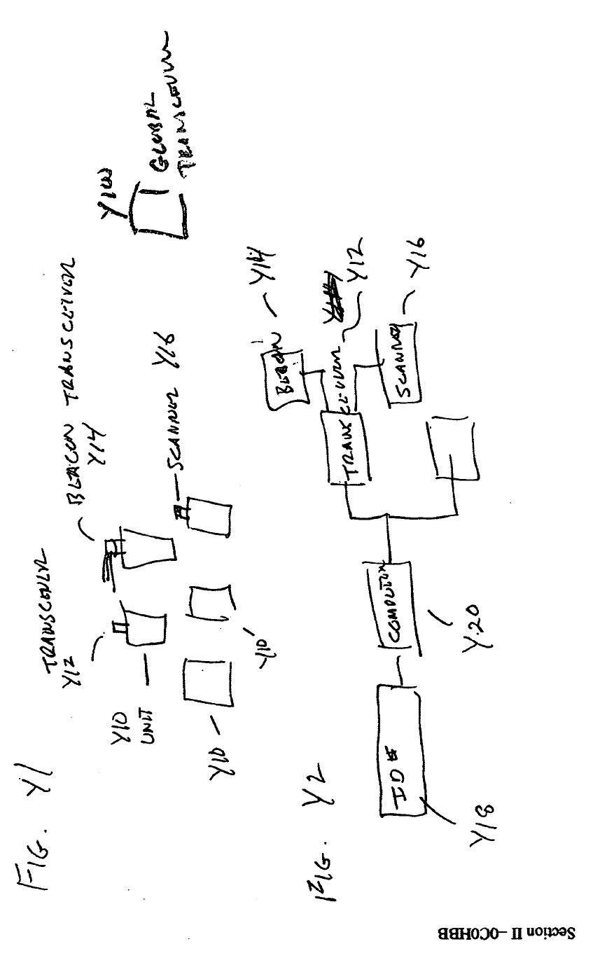

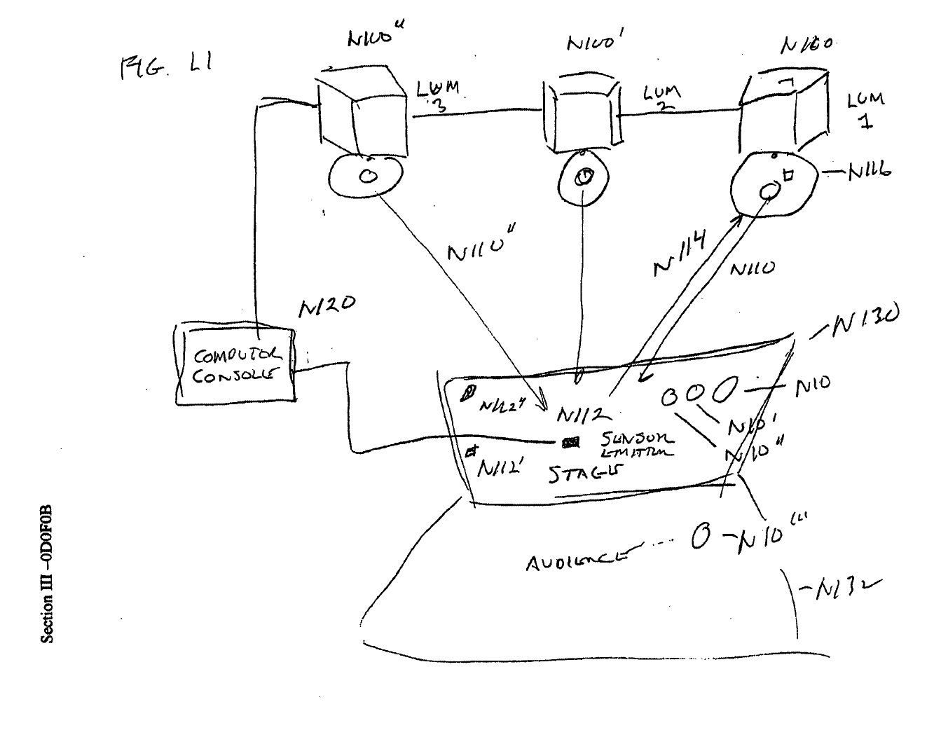

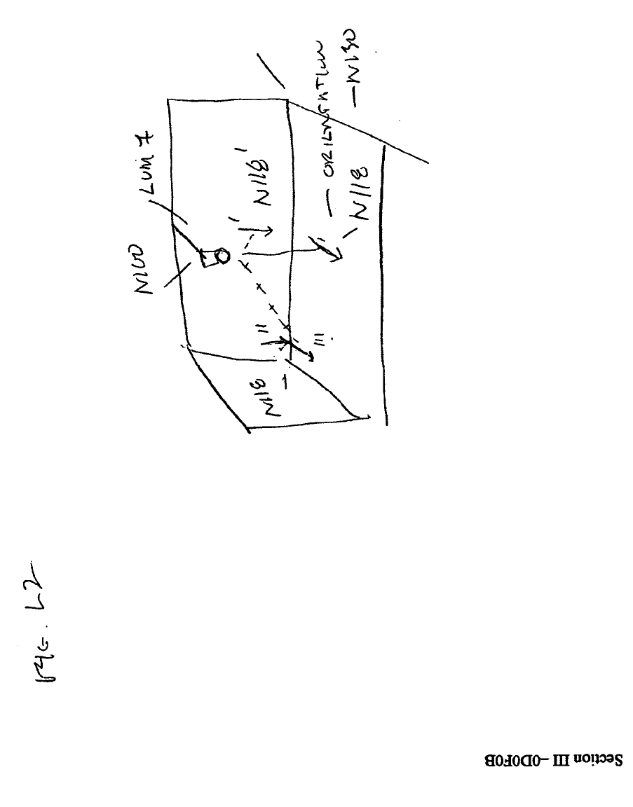

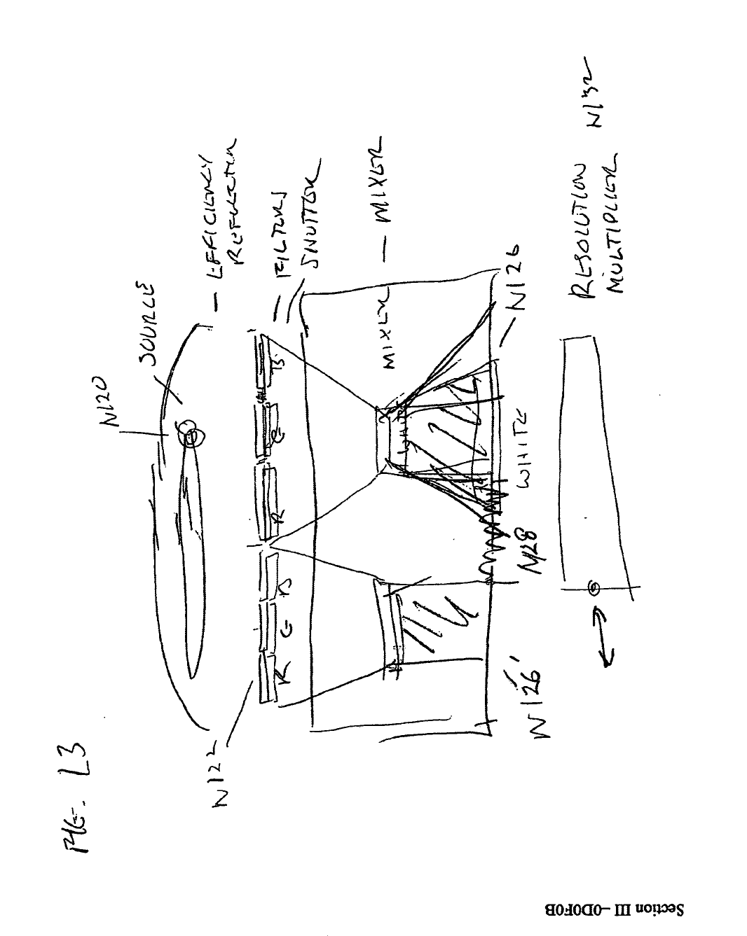

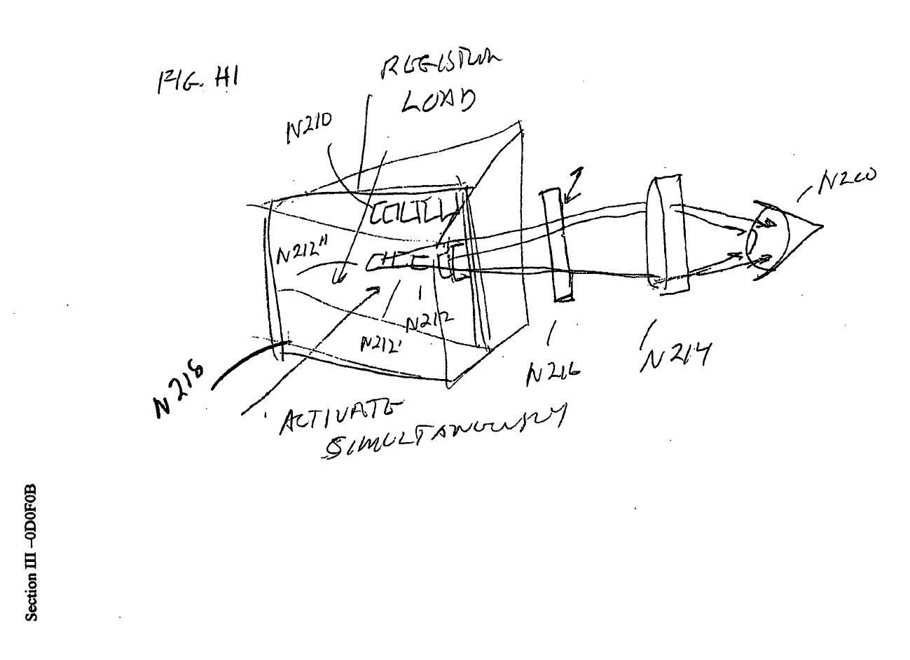

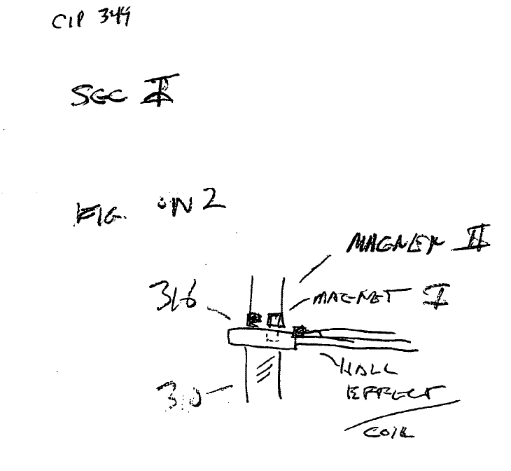

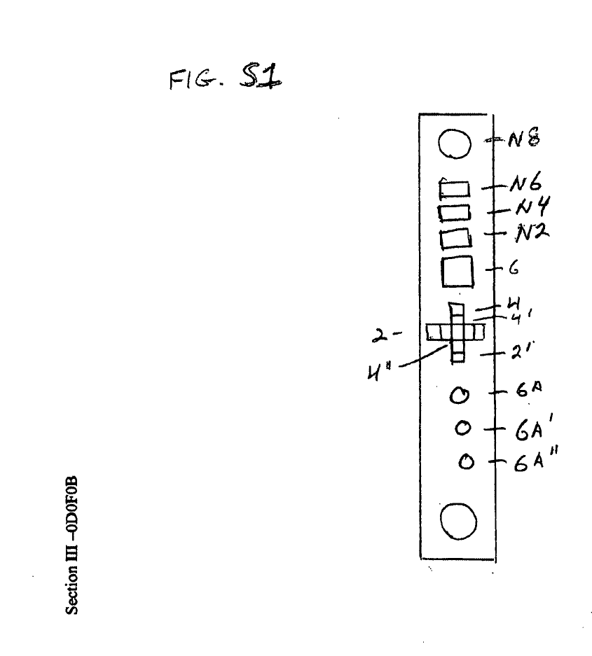

FIG. 16 presents a block diagram of a game embodiment of the present invention

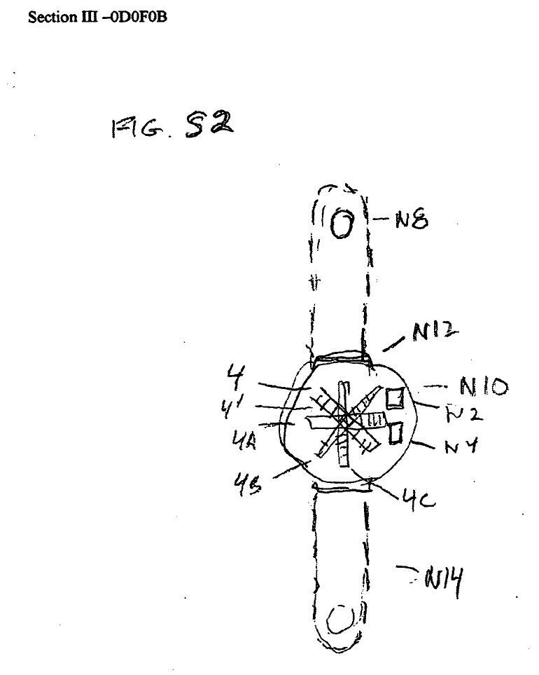

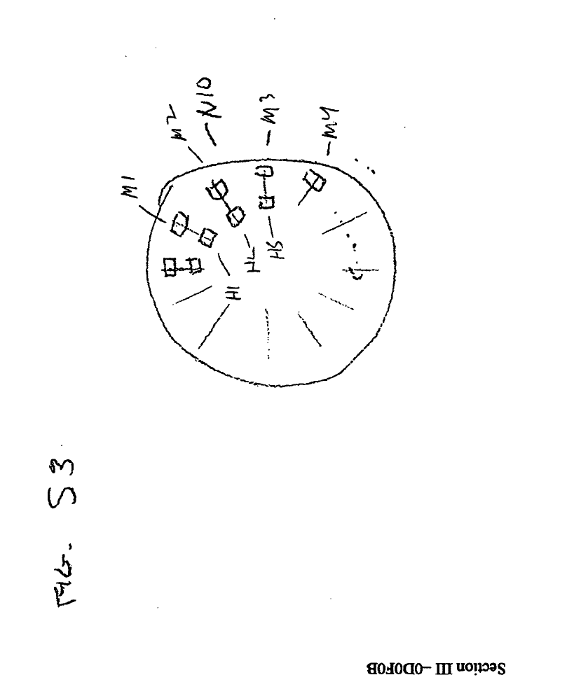

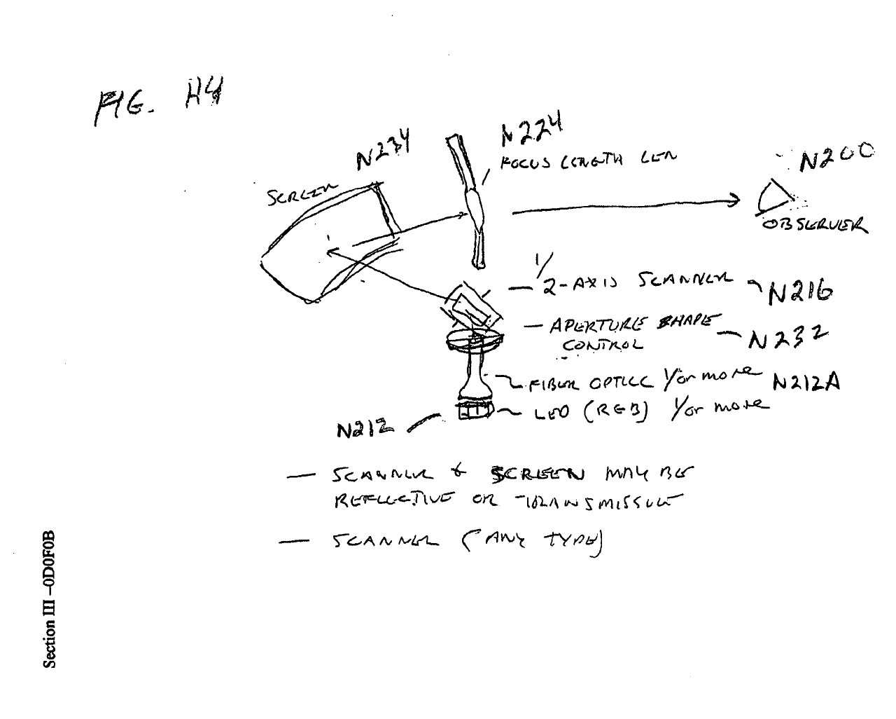

FIG. 17 presents a top diagram of an autostereoscopic embodiment of the present invention

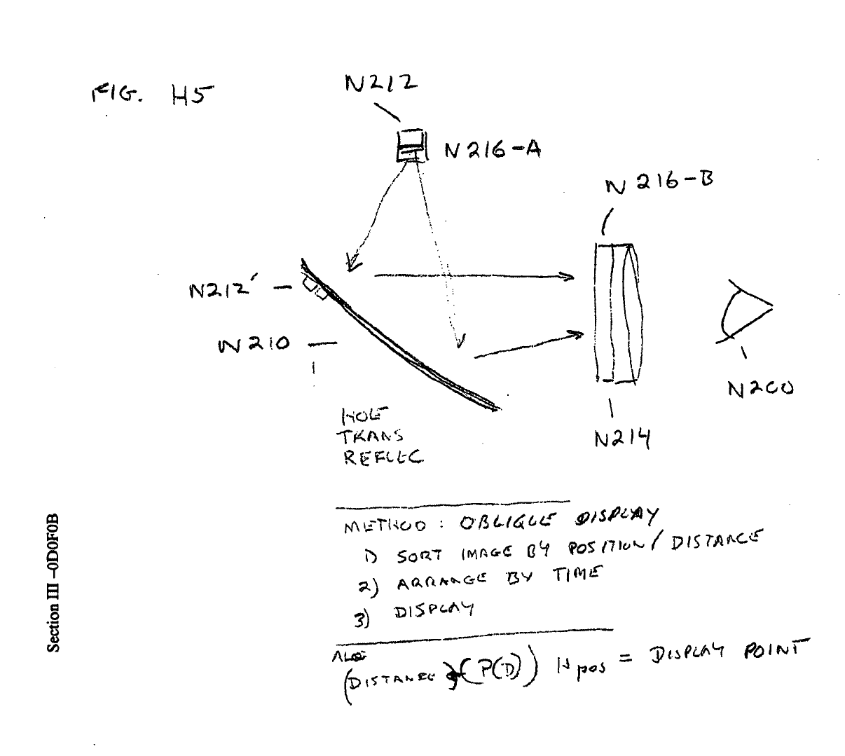

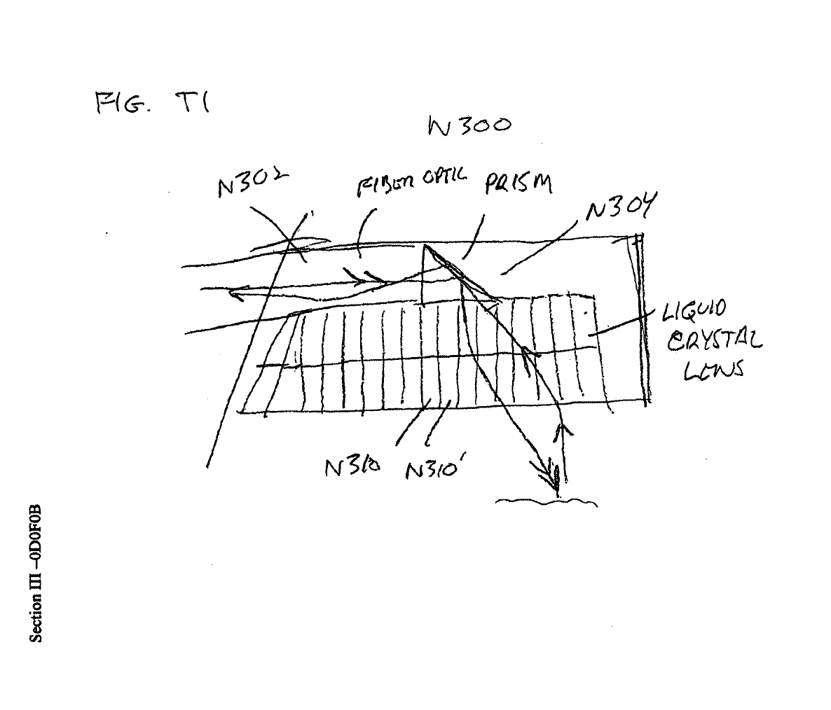

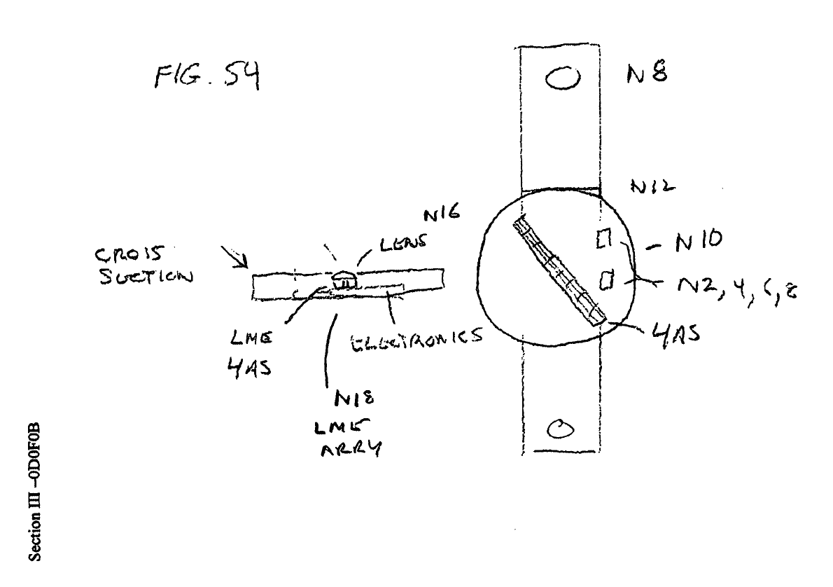

FIG. 18 presents a top view of the wand autostereoscopic embodiment of the present invention

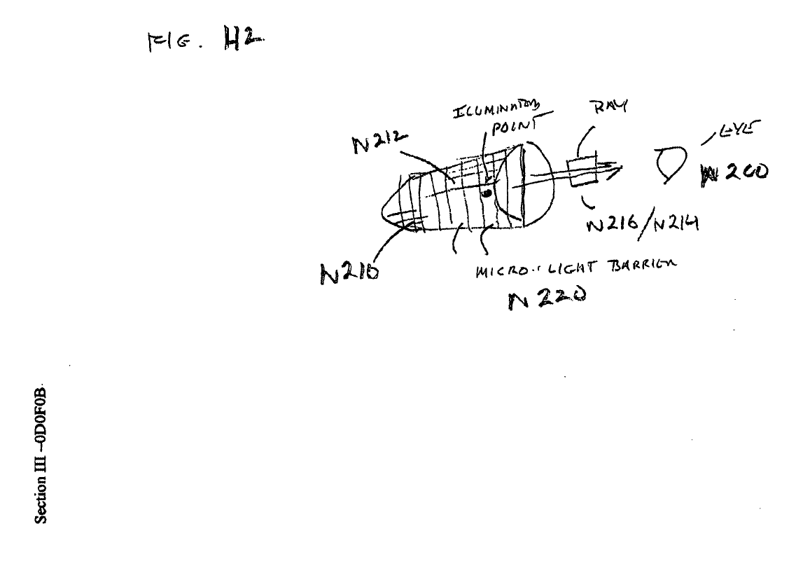

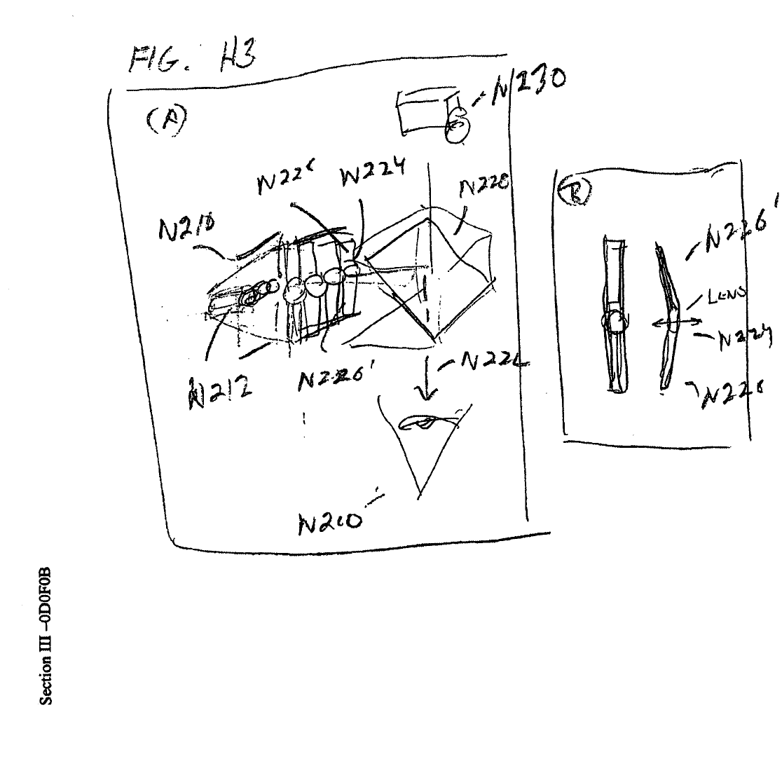

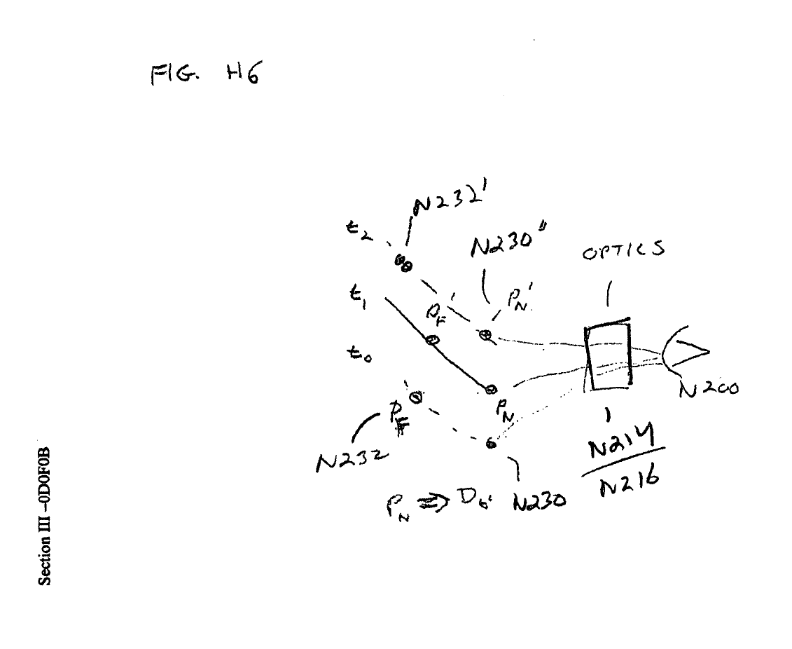

FIG. 19 presents a perspective view of the three detector autostereoscopic embodiment of the present invention

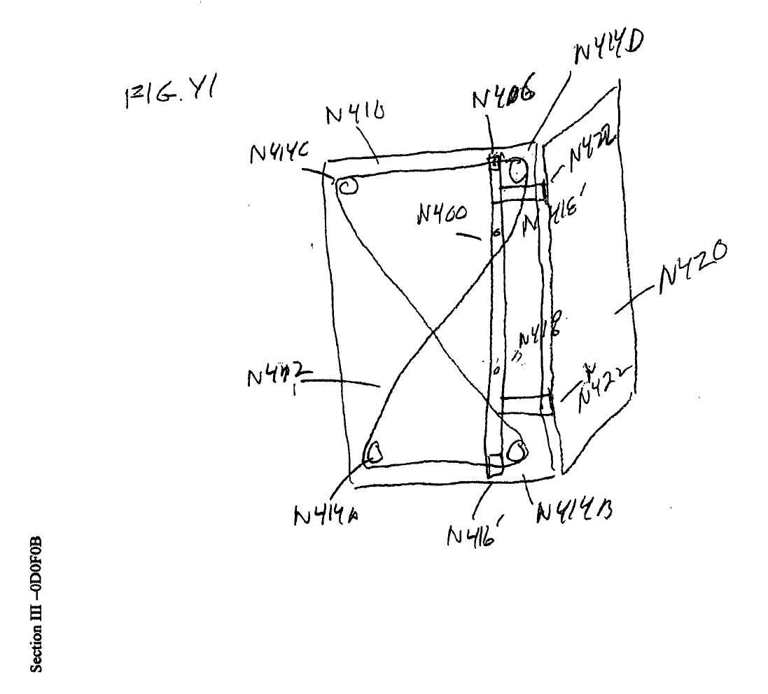

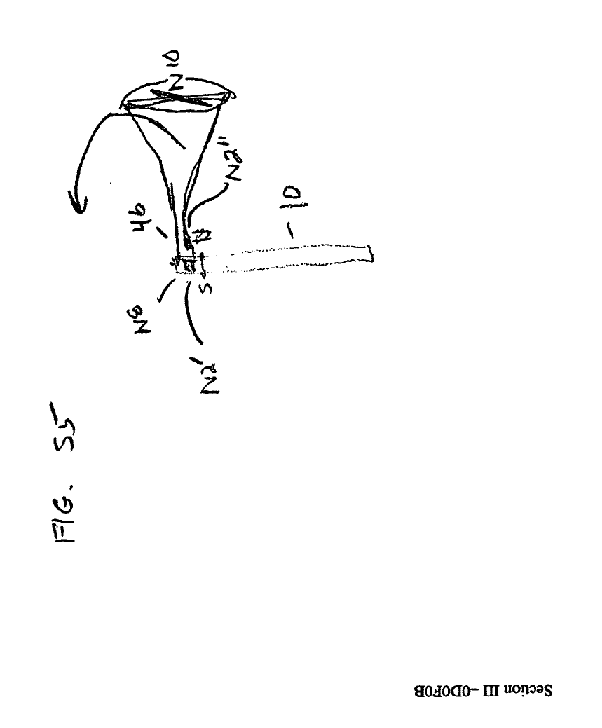

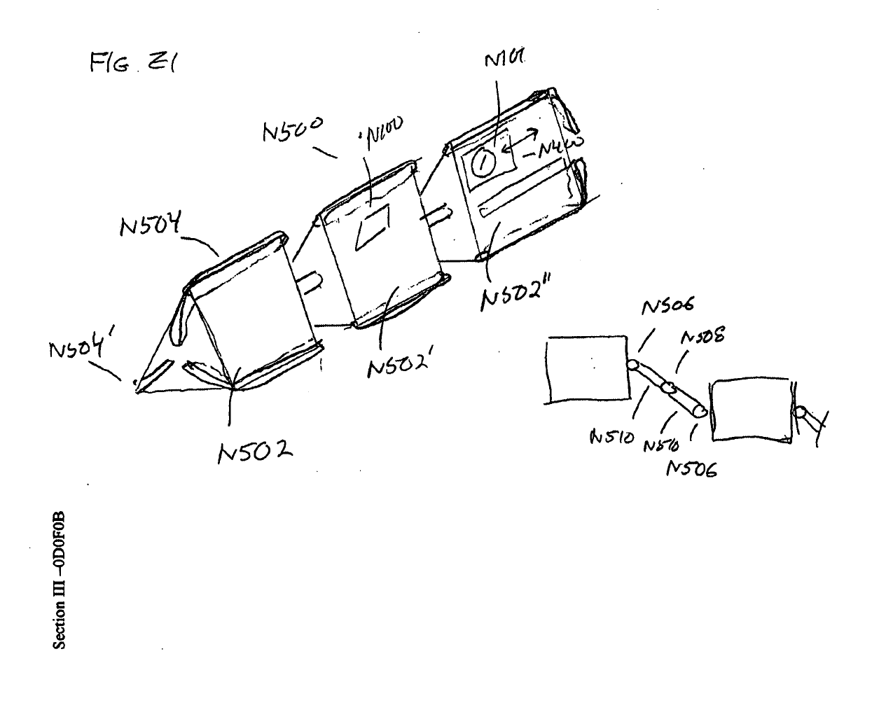

FIG. 20 presents a global orientation autostereoscopic embodiment of the present invention

FIG. W1 presents a wand registration embodiment of the present invention

FIG. W2 presents a perspective view of the wand registration embodiment of the present invention

### DETAILED DESCRIPTION OF THE INVENTION

The performance wand display system is designed to provide a novel visual and auditory experience and artistic medium for artistic, promotional, educational, entertainment and other assemblies. An example of a novel application would be to distribute a performance wand display in the form of a pennant to each fan at a night sporting event such as Monday Night Football. During halftime, or in response to a touchdown or other memorable incident, the show director, by employing the projector-receiver system, could orchestrate in real-time, precise explosions of light and sound throughout the audience including the display of text and graphics visible across the breath of the stadium. Each member of the audience becomes a pixel in a gigantic screen, and a voice in a gigantic chorus.

Utilizing the novel features disclosed in the present invention, the visual and audio response is precise and independent of the dynamic location of the member of the audience or display wand. Further, as a further benefit of the novel features and combinations of the present invention, the cost of implementing the method of the present invention is substantially less than other approaches and for the first time, practical and competitive in the marketplace. The performance wand display system may be employed at any assembly, large or small, or applied to any structure. Also, the wand display may be incorporate a message, song or game, and continue to operate after or independent of a performance or assembly.

Although the term performance wand is used to describe the simple and autostereoscopic effects module, it may be understood that the module or wand may take any shape or be incorporated into any independent handheld, worn, or positioned effects device including but not limited to tickets, badges, buttons, globes, cylinders, signs, sashes, headdresses and emblems affixed to any object, moveable or stationary.

FIG. 1 presents a block diagram of the principal components of the performance wand display system including the control board or program storage medium 99, the directional projector 90, the directional signals 98, 98′, 98″, and a multiplicity of the receivers or wand displays 30.

FIG. 2 presents a perspective view of the present invention including a illuminated wand 30 with some or all of the elements of the wand of FIG. 1, having one or more light emitting elements 36, a connecting member 20, handle 10 and an active receiver 80 capable of receiving optical or acoustic signals.

In operation, the show director at the control board 99 or instrument 99′ sends a sequence of commands, live or from a stored visual or audio program, to the projector 90 which emits a precisely timed series of directional signals 98, 98′, 98″ programmed to activate the wand displays 30 at a precise location. In its simplest embodiment, the projector 90 displays an image at a specific wavelength on the audience which causes the wavelength-specific wand display trigger to activate. The projector 90 may also transmit a program sequence for later execution and display. Each wand may contain a unique encoded identifier entered during manufacture, at time of purchase or distribution or transmitted by the projection system to the audience at any time including during the performance. The details of the directional signals and triggers, including complex and efficient protocols are disclosed in FIG. Px.

A preferred simplified embodiment which is representative but not limiting of the handheld part (hereinafter called the “wand”) of the present invention may be constructed from a wand having an LED 36, a receiver/discriminator logic 80 with a LED driver output, an IR sensitive phototransistor and a power source such as a small battery. This unit may be part of the event ticket, sandwiched between layers of paper, and as a button, pen, necklace, earrings or adhesive sticker, for example. An acoustic speaker 70 driven the logic 80 may be included in the wand.

The present invention substantially improves the performance and interchangeability, simplifies the manufacture, and reduces the cost of the magic wand. Concepts related to three-dimensional presentations disclosed in co-pending applications are incorporated by reference and may be applied to the inventions presented herein.

FIG. 3 present a preferred embodiment of the active display wand 30 of FIG. 2 having a handle, a supporting member, and an electro-optic assembly mounted on the elastic member, having a power source, microprocessor, one or more light emitting elements, and a cycle state indicator. One low cost and simple construction of the preferred embodiment employs a rigid plastic handle, a flexible plastic supporting member having two mounting posts and an electro-optic assembly constructed of a 3V disk battery, an low cost, 8 bit microprocessor with 512 bytes of program and data ROM, seven monochromatic light emitting diodes, a single stationary contact post and a single bendable metal wire, mounted on FP4 circuit board.

FIG. 3(a) shows a compact package with a receiver 80 mounted on the top.

FIG. 3(b) shows a compact package on a lanyard 90 with a handle 10.

FIG. 3(c) shows a compact package with an elongated connecting member 20.

FIG. 3(d) shows a volumetric sphere 92 mounted on the connecting member 20. Power 96 and power on switch may be placed in the handle 10.

FIG. 4 presents a preferred embodiment having a handle 10, a connecting member 20 and the active wand member 30 comprised of a microprocessor 32, a power source, one or more light emitting elements 36, 36′, and an activating switch mechanism 40. The obvious connections between the electronic elements are well known in the art and are not shown. All of the components are mounted on a single circuit board 38. The activating switch mechanism 40 contains a fixed contact 42, a moveable contact 44, a first post 46 affixed to the connecting member 20 and protruding through a slot 48 in the circuit board 38. In operation the circuit board 38 pivots about a second post 50 protruding from the connecting member 20 causing the first post 46 to press the moveable contact 44 onto the fixed contact 42, thus closing the electrical circuit. The closed circuit triggers the display of pattern by the light emitting elements 36, which had been programmed into the data memory of the microprocessor 32. Other known effects 70, such as audio speaker, microphone, vibrator, fog, moisture, scent, and texture and tactile response may be incorporated and controlled by microprocessor. Reference of this effects are omitted in subsequent drawings for clarity purposes only and these effects may be optionally incorporate in all subsequent presentations.

FIG. 4a presents another preferred embodiment wherein said first post 46 is conductive and in operation contacts two fixed contacts 42, 42′ closing the circuit.

FIGS. 4b and 4b′ presents another preferred embodiment wherein said first post 46 is position in an internal cutout 22 in at one end of the connecting member 22 and in operation forces moveable contact 44 against fixed contact 42.

FIG. 4c presents another preferred embodiment wherein a cam 52 in placed on second post 50 causing the moveable contact 44 against fixed contact 42.

It may be understood that the embodiments of FIG. 4, 4a, 4b, 4c may be constructed in a manner to snap onto a protruding second post 50 with sufficient form to control the motion of the active wand member to the plane of the active wand member, or alternatively set within a cut out 22 in the connecting member 20. The connecting member 20 and the handle 10 may be of integral construction.

The connecting member 20 may be of an elastic material. Alternatively, the handle 10 may be constructed of an elastic material, including a composite including elastic foam 14 and a rigid core 16. A durable cover 12 may be applied in the form of a plastic skin.

The microprocessor may be programmed by the user through one or more switches 60, 62, 64. Various programming protocols are well known to those in the art. One preferred protocol assignees the function SET, DOT, DASH to three switches 60, 62, 64, respectively. In operation, the user holds the SET button for a proscribed amount of time, for example 5 seconds, which causes the microprocessor to enter the PROGRAM MODE, indicated by flashing one of the light emitting elements 36. The user then enters the Morse code of the letter desired using the DOT-DASH switches 62, 64 followed by the SET button.

Alternatively, holding both DOT-DASH closed for a proscribed amount of time, for example 10 sec may indicated the PROGRAM MODE, with a short time, indicating the end of the coded letter. The sequence of switches closed and time held closed may be used for other functions including but not limited to choosing display sequences, patterns, or games; on or sleep, set time in a clock wand, and general programming.
Post and internal sot
Post and base slot
Post and cover defined slot
Slot and Slot
(Programmable dot-dash-set)

FIG. 4F shows a preferred embodiment having a rotational connecting member 20 shown as a ball 26 and rod 20′ both of which may be made of elastic materials situated in a complementary socket in the handle 10. the distal end of the connecting member 20 may be retained by the handle 10 by a rotatable stop shown as an aperture 24 in the handle and a cap 22. The ball 26 may have two switch contacts 42, 42a affixed which in operation are closed by contact with conductive region 44 affixed to the socket 26a, thus providing one or more reference locations relative to the position of the handle. An audio speaker 60 and tactile element 62 such as a vibrating weight, heating element, or texture control such including surface texture and moisture may also be included in all the embodiments of the wand included in this disclosure.

FIG. 4G shows a preferred embodiment having a rotational connecting member 20 shown as a rod 20′ of elastic materials affixed at the distal end 22 to the handle 20. the active member 30 is affixed to the connecting member 20 at by means of a hook 27,1 though other well known methods of attachment may be employed.

FIG. 4H shows a preferred embodiment having an active member 30, handle 10 and connecting member 23 with a conductive region 44 electrically affixed at 41 to the active member 10 and affixed 22 to the handle 10. In operation the conductive region 44 of the connecting member 20 contacts the switch contact 42 when the active member is displaced about post 50. In FIG. 1H1 the conductive region 44 closes a circuit between switch contacts 42, 42a.

Note: There is no FIG. 4I

FIG. 4J shows another preferred embodiment of the prior wands having an autostereoscopic optical component 200 and a position feedback signal 201 such as a timing sequence based on the cycle time, or absolute encoder, etc. FIG. 1J1 shows an autostereoscopic component having a multiplicity of light emitting elements positioned as each pixel 202, 202′. FIG. 1J2 shows an autostereoscopic component having a miniature scanning mechanism 204. The scanning mechanism may be one or more resonant micromirrors, a rotating micro-prism, a resonant micro-waveguide or other scanning mechanism.

FIG. 4K shows an autostereoscopic component having a variable focal length control such as variable focal length mirror or lens 210. In operation the output of the light emitting elements 36, 36′ is focused into a distal point of varying virtual focal distance 214.

FIG. 4L shows an autostereoscopic component having a variable focal length control such as variable focal length mirror or lens. In operation the output of the light emitting elements 36, 36′ is focused into a distal point of varying virtual focal distance.

Reference and incorporation of my co-pending applications related to 3D displays in incorporated and the techniques disclosed therein may be incorporated in the present display.

FIG. 5 presents another preferred embodiment having a handle 10 set parallel to and longer than the active wand member such than when held the wand member 30 passes between the handle 10 and the center of rotation at post 50, a connecting member 20 and the active wand member 30 wherein the active wand member 30 is fully and continuous rotatable about post 50 as shown. In operation, a switching mechanism 40 detects one or more positions of the active wand member 30 relative to the connecting member 20.

FIG. 5a presents another preferred embodiment of the switching mechanism 40 having two contacts 42, 44 on the active wand member 30 which upon rotation closed a circuit by contact with a conductive region 54 on the connecting member 20. Post 50 may be rigidly affixed to the moving wand member 30.

FIG. 5b presents another preferred embodiment of the switching mechanism 40 having two or more contacts 42, 44 on the active wand member 30 which upon rotation closed a circuit by contact with a conductive region 54 covering a proscribed portion of the angular surface of stationary post 50 on the connecting member 20.

FIG. 5c presents another preferred embodiment of the switching mechanism 40 having two contacts 42, 44 on the active wand member 30 which upon rotation closed by cam 52 pressing the contacts together.

FIG. 5d presents another preferred embodiment of the switching mechanism 40 having two magnetically responsive contacts 42, 44 on the active wand member 30 which upon rotation are closed by proximity to magnet 56 on the connecting member.

FIG. 6 presents a coding protocol of the preferred embodiment of FIG. 2 wherein two or more angular regions 70, 72 are recognized by the microprocessor 32 based on the position or timing of the rotation of active wand member 30 and the displayed text 74, 74′ is appropriately oriented.

The active wand member 30 may be rod, plate, circle or other shape having a center of gravity 31 displaced from rotation axis on post 50. One advantage of the solid, opaque circle is that is occludes the background light.

The present invention may be used as the basis of a game of skill and perseverance including parameters such as: the duration of motion, the period, the precision of path and repeatability, the response time to presented images. Moving images and text may be presented. Players may be required to decode obscure images, match images in space, synchronize or repeat movements.

FIG. 7 presents a fan disk embodiment of the present invention, which may be fixed to handle or free flying as a solid Frisbee. The active wand elements include those previously referenced. The light emitting elements 36, the microprocessor 32 are shown with one or more magnetic field sensors 110, 110′ such as Hall effect devices, incorporated to detect an external magnetic field such as the earth's natural field as a position reference for free flight. The light emitting elements 36 may employ light pipes 116 such as fiber optic channels to transfer the exit aperture to the perimeter top, bottom or side.

FIG. 7a shows an encoded precession based on the number of periods or cycles of the image 114 in the present invention. When the full cycle precession period is greater than 2 seconds, viewers at all radially positions will observe the full scanning image.

FIG. 8 shows a rotatable display having the aforementioned components in FIG. 3 where the center of gravity 31 may be displaced from the center of rotation post 50 be a swinging motion to position 31′ by displacing an elastic mass 33 to position 33′. Rotational energy may be stored by one or more rotational masses 33 which may be distributed in any symmetrical or asymmetrical manner about the center of rotation.

FIG. 8a shows a mass 33 on a spring 33a to store energy.

FIG. 8b shows a deformable gel as an method for storing energy.

Other methods known in the art of rotational energy storage may be employed, including electrical, chemical, pneumatic, hydraulic and various mechanical approaches.

FIG. 9 shows a preferred embodiment of the projector unit 90 of the present invention where the controlling processor 100 receives input from the musical instruments 102, a MIDI or data channel 104, or other source 106 such as a manual operator, voice control, etc. The pattern 96 may be a simultaneously projected image or scanned beam 98, 98′, modulated both temporally and spatially. Any wavelength, visible, IR or UV (black light) may be used as the signal carrier, which may include a carrier frequency to differentiate from background optical noise. The pattern may include a programmed data sequence received and stored by each wand 30. The data may be automatically triggered at a later time internally, or by a second acoustic, optical, motion, magnetic or radio frequency signal.

An infrared projector with both directional and omnidirectional modes modulates a signal with a carrier frequency of 36 KHz or less which may be used to for simple commands, or a higher frequency for more complex transmissions. Standard digital IR communications protocols may be also employed.

In the simplest mode of operation, the wands are identical and distributed to the audience in any manner. The projector transmits a spatially and temporally controlled signal which activates the wand correspondingly. A more complex logic permits the transmission of an spatially modulated identity signal to the wands in a specific location, which “fixes” their responses to subsequent commands. One example would be the transmission of an spatially modulated identity signal of 5 seconds duration, followed by an activation signal of 100 milliseconds. Another example would be the spatially modulated transmission of a digital identity code which each wand would retain. Under these circumstances, the audience could move about with the wands retaining their original location information.

The utility of transmitting a spatially modulated digital identity code is manifold: it permits the wands to be uniform during manufacture and distribution, it automatically corrects for errors in seating plans, and allows games to be developed based on the location of the participants at a given time.

The visual effects of a digitally encoded identity and program are extensive. Real time response permits moving images without flicker effects if desired. Complex optical effects may also be incorporated. Once the digital program is downloaded to the specified wands, the mechanism of initiating the program sequences may be global or localized, augmented by other transmitting media as well, such as acoustic (tied to a specific frequency or sequence in a song), ultrasound, radio frequency, tactile (a switch) or environmental (temperature, wind, motion, etc.).

In addition, the acoustic effects when the wand incorporates an audible speaker have utility. In a concert, the audience becomes an instrument, controlled by the band, having full control of the timing, location, frequency and volume of each wand. Three-dimensional and interference effects are clear benefits from the precise temporal control and spatial distribution.

The control system or control board may resemble an instrument, such as a synthesizer keyboard or other integration of existing controls including electronic guitars, wind and percussion musical devices. Thus, one may integrate the visual and/or audio control of the wands into the live music performance.

FIG. 10 shows a preferred embodiment of the audio control 102 of the projector unit 90 of the present invention where the controlling processor 100 receives input from a keyboard type musical instruments 102 with regional controls r1u, r1l, r2u, . . . corresponding to audience locations R1u . . . /

FIG. 11 shows a partial schematic diagram of projector—receiver trigger system with a carrier modulated signal 98 and a corresponding discriminator circuit 34 in the electronics of the display wand 30. For illustration purposes, the embodiment shown also employs a directional scanner 112 though either scanning, image projection or global trigger embodiments may be used.

When using infrared signals there exists the problem of interference from other IR sources. A simple method to eliminate these effects is to modulate the carrier beam within a specified frequency range. By employing a discriminator circuit 34 which may be an analog bandpass circuit, a software routine or other known technology, the present invention may be used without error in common venues such as outdoor arenas, sports stadiums, theatres and clubs.

FIG. 12 shows a partial schematic diagram of projector—receiver trigger system using a chromatic signal and employing an optical bandpass filter 122 on the receiver circuit. Another embodiment of the present invention employs a specific wavelength of radiation including visible light which is not intense in the standard venues where most illumination sources have irregular spectral distributions. The bandpass filter may utilized any known optical bandpass technology including but not limited to a simple colored gel or more sophisticated interference filter.

FIG. 13 shows a block diagram of projector—receiver ID trigger system. Each receiver 30 is transmitted an identifying code “ID” 98, 98′ and/or program based on the receiver's location at the time of transmission. A second code, either transmitted to the same or a different receiving circuitry 80′ acts as a trigger, to initiated the previously transmitted or encoded program. The trigger signal may be optical, electromagnetic, RF, global, ultrasonic, acoustic, temperature, wind or even olfactory. These technique may be employed to transmit a program which will automatically commence at a fixed time after the transmission, seconds or days, or in response to external events including an action of the audience utilizing input devices, switches 42, 44, optic or acoustic receivers 80 on the display wand 30.

FIG. 14 shows a perspective view of an image projector 90 embodiment of the present invention where a spatial modulator 142 is utilized to impart directionality to the carrier frequency modulated signal 98 emitted by the signal source 140. An intermediate modulator 142′ may be employed to impart the carrier frequency. The spatial modulator may be a digital micromirror device, a liquid crystal shutter matrix, an acousto-optic modulator or other known modulator technology.

FIG. 15 shows a perspective view of a scanning projector embodiment of the present invention where one or more narrow modulated beam 98 is scanned across the audience. The projector source 152 may be a matrix of laser diodes, LEDs or other electronically modulated emitter source. Alternatively, the modulator may be a micromirror device, a liquid crystal shutter matrix, an acousto-optic modulator or other known modulator technology. The scanning optics may be mechanical such as a motor 154, electro or acousto-optic, or other know scanning technology.

### SUMMARY OF PREFERRED EMBODIMENTS

Wand
   Simple
   With LED
   With Audio Speaker
   With Motion trigger
   With vibrating and other tactile effects
   Producing smoke, moisture, change of temperature.
   Receiving for data or trigger R, UV, ultrasound, RF, EMF, visible light, audible sound
carrier signal
   simple on off
   modulated to remove interference
   with data
   with timer
carrier wavelength
IR
   Visible
   Visible modulated a non visible frequency
   Black Light (UV)
   AO
   RF
Projector
   Full frame
   Vector scan
   Raster scan
   Line scan
   Static (audience or starts move in and out of range)
Controller
   Pre programmed
   Live
   Connected to musical instruments
   Connected to movement
   Mask
   Resembling a Synthesizer Keyboard or other musical instrument
   Resembling a Lightboard
   Videotape, DVD, CD, etc.

Game Embodiment of the Present Invention

The present invention may be the basis of a complex public game using general spaces and the Internet.

FIG. 16 presents a conceptual block diagram of the receiver embodiment of the present invention. Each wand receives a unique identification code during manufacture or sale. A series of projectors transmit a game code in each venue. The incorporated receiver registers the code when the wand “visits” the projector space.

In another preferred embodiment, the receiver 80 in the wand recognizes a pattern presented on an Internet site and stores a transmitted code. Wands containing the code are activated by a signal projected by projector 90 in the activating venue displaying a pattern on the light emitting elements or a sound. It may be understood that the wand of the present invention may also contain a audio input/output, a motion detector and/or vibration mechanism as is found in cell phone and beepers. The venue may be a concert, fair, celebration, ceremony, shopping mall, store or other location. One advantage of the present invention is its low cost of manufacture and implementation.

In another preferred embodiment, the light emitting elements 36 may act as a transmitter, sending data or signals to proximal wands as part of the game.

Unique elements of the game are:
One or more projectors
One or more receivers
Transceiver
Each unit with a unique ID
IntraWand transmission—
Internet Communication—
Using IR

Scan Image—On-Off at reasonable speeds on any monitor—The game may employ the Internet providing a visual scannable image or data on any Internet monitor of in response the transmission of specific data by the user. Maps, clues and other instructions may be provided. In a more sophisticated version, GPS (global positioning satellite) interfaces may be employed.

Unit programmable using 2 or more button Morse code (dot, dash, hold both to set) or other code.

The data received by the wand from the projector, together with the motion and or response of wand during the performance or operation by the user, may be retained permanently in the wand memory (OTP, flash, battery backed, smart card, etc.) or for a predetermined period of time. This information may include music in MP3 and other formats. The combination of data plus activity may be used as a basis for awards and prizes. For example, a different data combination (abstract, visual, audio or other format) may be download at each performance if the user is seated within the first ten rows. Collecting all the combinations from a tour may entitled a person to a “back stage” pass on the next tour.

The present invention may incorporate the three dimensional visual display systems of my prior and co-pending U.S. patent applications.

FIG. 17 presents a top view of the preferred viewframe registration embodiment of the present invention. Although handheld or independent placed wands may be generally positioned by the user, an improvement in the global viewframe registration of the displayed pattern of each wand may be accomplished by providing a reference point. This reference point 102 may be established by transmitting one or more direction beams which are recognized by a wand viewframe reference system 110 in each of the wands 30. The reference system 110 recognizes the angular direction to the reference point 102 in relation to the centerpoint 112 of the wand and generates a centerpoint offset 114. The centerpoint offset 114 is used by the display electronics 32 to shift or adjust the pattern displayed by wand emitting elements, such as 202, 202′, varifocal optics 210, or scanner 204.

The orientation of the display wand pattern is important in an horizontal parallax autostereoscopic system. Generally, the normal positioning of handheld or mounted wands obviates the requirement for an orienting system. However in certain applications, such as a thrown or rolling ball, balloon or free swing wand, the dynamic adjustment of the displayed pattern to the immediate orientation is desirable.

A gravity sensor, such free rotating offset mass, MEMS arm, or other known technology may be integrated with the viewframe, location and data receivers to provide global oreientatino to the displayed pattern.

FIG. 18 presents a detailed top view of a single wand 30 for a reference system 110 using a omnidirectional point source reference point 102 and a wand reference system 110 having the two analog photodetectors 122, 124 and an controlled dispersive element 130 which transforms the reference point beam 104 into a defined spatial pattern such as but not limited to a gaussian energy distribution 130. The energy levels received at the photodetectors 122, 124 may be compared and an offset 114 generated from the known energy distribution and the photodetector levels.

The orientation of the display wand pattern is important in an horizontal parallax autostereoscopic system. Generally, the normal positioning of handheld or mounted wands obviates the requirement for an orienting system. However in certain applications, such as a thrown or rolling ball, balloon or free swing wand, the dynamic adjustment of the displayed pattern to the immediate orientation is desirable.

FIG. 19 presents a persceptive view of a reference system 110 having two offset reference points 102, 102′ and three analog photodetectors 122, 124, 126. By comparing the relative energy levels of the three photodetectors, the spatial orientation of the wand 30 may be determined. A more detailed orientation may be achieved by differentiating the reference points 102, 102′ by modulating the cycles such as turning one point on for 5 milliseconds and the second for 10 milliseconds, using different radiative spectra, or encoding the signal. A multiplicity of detectors may be Iused to increase resolution.

In a system where the data receiver 80 and reference system 110 are separate, a coordinating signal may be sent to the data receiver.

FIG. 20 presents the use of a global reference such as the ambient or earth's magnetic or gravitional field to provide a wand orientation. The circuit may be programmed to reference the maximum, minimum or other phase of the field. The orientation reference is then used to properly shift the displayed pattern relative to the image position of the receiver.

It may be understood that the viewframe reference system may utilize visible or non-visible radiation including but not limited a constant, scanned or modulated beam of visible, uv, infrared light, microwave or radio frequencies. Propagation timing using light, radio frequencies, sonic or ultrasonic wave may also be used, as well as interference patterns.

As is shown in recently issued US Patent related to autostereoscopic wands, the autostereoscopic effects module or wand may employed a multiplicity of technologies. All of the embodiments shown therein may be incorporated in the present application.

FIG. W1 shows a perspective view of a handheld embodiment of the present invention where one or more light modulators 310 which may include but are not limited to emitters, shutters or reflectors, LEDs, etc., are controlled by a computer 150 mounted on a moving platform 120 and rotated about a handle 312. As shown in my related issued patents for wands and stationary displays, an image may be produced by the appropriate timing and registration which may be accurately determined by reference to one or more indices 316 on the handle 310 and one or more sensors 320 on the moving platform 120. The index(ices) 316 may include but is not limited to a magnet, metal tooth, reflector, cam, hole, contact, etc, which is sensed by sensor 320 which may include but is not limited to a hall effect switch, magnetic switch, current or voltage sensing on a coil, transmissive or reflective optical encoder, cam activated switch, capacitance sensors, motion sensor, magnetic sensor, ambient light sensor, proximity sensor, etc.

In a preferred embodiment, three sensors 320 spaced at different angular positions about the handle 312 to create three intervals 318A, 318B, 318C which are employed to determine the direction and angular velocity of the moving platform 120. In operation, the computer 150 records the time duration of the intervals which at reasonably constant angular velocity which exhibit three values representing a short, medium, and long duration. If the sequence is short-medium-long than the rotation, as shown in FIG. X would be clockwise. If the sequence is long-short-medium, than the rotation is the opposite. The period may be determined by the trigger of any single sensor 320, or the interval between sensors.

An alternative configuration may use a single sensor 320 and a plurality of irregularly spaced indices 316 such as but not limited to magnets, cams, etc, with the same principle applied where the timing differential between index 1 to 2 and 2 to 1 is used to determine direction and velocity.

FIG. W2 presents a side view of the embodiment of FIG. W1 FIG. Q1 shows the performance widget system of the present invention from FIG. 2 further showing the integrated projector 90 which includes both the directional signal communication encoding 98 and the visible light luminaire control.

FIG. Q2 shows separate visible 410 and non-visible sources 140 together with spatial modulators 412 and 414 respectively and integrating optics 416 which may include but is not limited to a prism, dichroic mirror or rapid shutter. The spatial modulators may be LCOS, DMD, LCD, or other spatial modulators performing the similar function.

FIG. Q3 shows a combined visible 410 and non-visible sources 140 together with a modulator 418 for the carrier frequency of control signal, herein shown as IR with bandpass filters 420 as the integrating optics 416. The control wavelength may be in the visible or non-visible spectrum, including a narrow band in the visible spectrum.

FIG. Q4 shows a movable projector 90 with a computer controlled yoke 430 popular in the industry. The images 432, 434, 436 produced by the projector 90 with a given velocity profile 438 will distort a static image. The present invention therefore has processing software which computes a corrected image 442 including a correction in data signal period, visible image intensity and color saturation related to the projection motion distortion 440. The geometric matrix vector transformations are well known in the industry.

FIG. Q5 shows a movable projector 90 with a computer controlled yoke 430 popular in the industry with automatic pattern correction tied to motion by automatic registration to the environment by one or more detectors 442 ties to the control system 99. During the registration, the projector scans until it illuminates the detector 442. The control system records its position and computes its orientation.

Section II

With reference and incorporation of my U.S. Pat. No. 6,404,409 and application Ser. No. 10/385,349

FIG. 1 shows the general concept of the autostereoscopic performance display system where the wand 30 presents an 3D autostereoscopic image to observer 10 by projecting different images 30′,30″ . . . , 30′″ during a sweep having a directional output 32, 34 which is viewable by only one eye 12, 14 of the observer 10. It may be understood that a non-3D image may also be presented if the output 32, 34 is the same. Combinations of 2D and 3D images may be interlaced and interspersed.

FIG. 2 shows a preferred barrier aperture embodiment of the present invention where the wand 30 houses light emitting elements 40, 41, 42 whose output 32, 34 is directional by a limiting aperture 46. It should be understood that the light emitting elements may be an LED, laser, laser array, microshutter, LCD, electronic paper, with a frontlight or backlit, using ambient or powered illumination.

FIG. 2a shows a preferred barrier aperture embodiment of the present invention where the wand 30 houses light emitting elements 40, 41, 42 whose output 32, 34 is directional by a limiting lens 48.

FIG. 2b shows a preferred barrier aperture embodiment of the present invention where the wand 30 houses light emitting elements 40, 41, 42 whose output 32, 34 is directional by a lenticular construction 48 48.

FIG. 3 shows a preferred barrier aperture scanning emitter embodiment of the present invention where the light emitting element 40 is scanned over a reflective screen 50 by scanning mirror 52 producing a multiplicity of virtual pixels 60, 60′, 60″ . . . . Typically, if the wand is waved at 4 Hz (back and forth), a 100 point image would be produced by modulating the light 40 at 800 Hz. Non-linear adjustments to timing and intensity are appropriate which approximate equal wand travel segments.

FIG. 3a shows a preferred barrier aperture scanning emitter embodiment of the present invention where the light emitting element 40 is scanned over a reflective screen 50 by a polygon scanner 54, either reflective or transmissive.

FIG. 3b shows a preferred barrier aperture scanning emitter embodiment of the present invention where the displacement of light emitting element 40 causes the output to be scanned over a static reflective scanner optic 56 and consequently onto screen 50.

FIG. 3c shows a preferred barrier aperture scanning emitter embodiment of the present invention where the displacement of light emitting element 40 in an arc about the aperture 46 causes the output to be scanned onto screen 50.

It may be understood that mechanical, optical, acoustic, electro-optical, MEMS, MOEMS, and other scanning systems are well known and may be applied to the present invention.

The present invention may be combined with the control mechanisms described in my aforementioned U.S. Patent and co-pending applications incorporated by reference herein. It is apparent that the image displayed to an observer varies according to their angular position relative to the output orientation of the wand.

It is a novel and desirable feature to be able to present a specific image to either an individual or a large audience. As described in my co-pending aforementioned application, this may be accomplished by adding a reference beam at the observer's or a chosen location.

FIG. 4 shows a preferred orientation reference emitter embodiment of the present invention where an orientation reference emitter 70 emits a beam 71 which passes into the wand 30 and is detected detector 72. It is apparent that the signal will be detected only when the wand 30 is orientation so that the aperture 46 and detector 72 are co-linear with reference beam 71. Upon detection of the signal, the image displayed may be appropriately shifted present the designated image to an observer in relation to the reference emitter 70. An array of detectors 72 may be used to permit the detection of other orientations.

FIG. 4a shows a preferred orientation reference emitter embodiment of the present invention where an orientation reference emitter 70 emits a beam 71 which passes into the wand 30. The intensity of the detected beam will vary in relation to the distance from the detector. By comparing the relative intensity between detectors, the two or three dimensional position may be calculated. This embodiment may be employed with fixed or scanning light emitters 40.

FIG. 4b shows a preferred scanning detector embodiment of the present invention where the reference beam 71 is reflected from screen 51′ onto scanning optic 52 and into detector 72. The intensity of the detected beam 71 will peak when the scanning optic 52 is directed to its position on screen 51′, and the relative position may be calculated. The detecting components may be incorporated into the projection elements using the same screen 51 and scanner 52. The detector 72 may be adjacent to the light emitting element 40 or co-linear by means of a dichroic reflector. The detecting beam may be modulated with a carrier frequency and data in the visible or non-visible electromagnetic spectrum. For example, infrared beams may be used, with a carrier frequency of 40 Khz and encoding a data signal which uniquely identifies each orientation emitter. This preferred embodiment would permit the wand 30 to present a unique image, sound, or other behavior to each orientation emitter which may be integrated with each wand or other device, fixed to a specific location, placed on a moving object such as a pin, hat or toy.

FIG. 5 shows a preferred transmissive, lenticular embodiment of the present invention where the scanned beam 32 transverse the screen 50.

FIG. 6 shows a perspective view of a preferred scanning embodiment of the present invention with multiple emitters 40, 40′ and a vertically dispersive screen 50 that transforms the horizontally directional beam 32, 34 into a vertical fan. A handle 10 of the wand embodiment is shown This technology permits observers at different heights to see a similar image.

It may be understood that the present invention may operate as an individual 2D or 3D pixel in a collection of similar wands (such as an audience or gathering), as a stand-alone beacon, or as a moving image display. The design may be a pin, hat, flag, banner, wand, sword, spoke, ball.

FIG. 7 shows a perspective view of a preferred ball 72 embodiment of the present invention with a offset weight 78 may be applied so that the ball automatically assumes a given orientation. The ball may be split with a motor 76 permitting part having the aperture 46 to rotate.

FIG. X1 shows a perspective view of an improved scanning embodiment of the present invention applied to a projection wand 30P. The improved scanning embodiment may also be applied to other 2D and 3D displays and projectors. The light source 200 output traverses the optional condenser optics 204 and transformed by the chromaticity and intensity pattern optics 212 into the illumination pattern generally shown in FIG. X1A where the intensity 330 of each of the additive colors, if a standard 3 color system, varies generally as a sine wave, but other patterns may be appropriated to defined conditions. In a minimum cycle embodiment, an exponential interlaced Base 2 pattern represents the preferred compromise between performance and error correction. The scan optics means 220, or alternatively 250, causes the pattern to cycle 320 across the audience 270 as a rate in excess of the visual integration rate of approximately 24 frames per second. The cycle causes the image seen by the audience to integrate the cycle 320 pattern displayed by the shutter 240 as a single image, and thereby a full color image may be produced with the color/intensity bit depth equal to the number of sub images presents during the full cycle 320. For example, if 8 bitplanes are displayed for each color c1, c2, c3, the full cycle would resolve 24 bit planes.

The scanning may be of any known method including acousto-optic, electro-optic, mechanical, color wheel, resonant, oscillatory or others. Also, the pattern may be scanned across the shutter array or the shutter array scanned across the audience. Generally, when the shutter array is comprised of the full matrix resolution, the pattern is scanned across the shutter array 240. FIG. X3 shows a preferred embodiment where the matrix resolution is increased.

FIG. X2 shows the application of the present invention to a 3 shutter system commonly used in 3 chip reflective DMD systems. Because each chip is filtered to present one of the three additive colors, the pattern 318 need only present a variation in intensity 330 as shown in FIG. X2A. The configuration is similar to FIG. X1, with the optional addition of a TIR prism assembly 242 and individual color filtered shutters 244, 246, 248.

FIG. X3 shows a preferred embodiment of the color integration of the preferred pattern embodiment where the pattern projector elements 350 project an image on the shutter 240 which is integrated and mixed by combiner 360 such as an integration rod or diffuser and output as distinct elements by the optical equivalent of a tapered fiber optic, and optically overlaid by a black spacer 362. The image is then scanned by scanner 250 to create a more complex image 370′ and projected 260 into the audience. An optional embodiment places the scanner 368 after the projection optics 260. The scanner and projection optics may be integrated as a single unit. Scanning technologies are well known and described in my co-pending applications which are incorporated in their entirety herein.

The pattern shown suggests a linear array but the actual line to line pattern may be offset to reduce the moiré effect and increase anti-aliasing possibilities. Other configurations disclosed in U.S. Patents by Stephan Meyer may be incorporated.

Also the current scanning embodiments may be applied to single, spaced or mosaic arrays of elements, independent or coordinated.

FIG. Y1 shows a self-assembling and organizing group of units Y10 (wands, or other robots) having a transceiver y12 in the form of a beacon y14 and/or scanner y16 which transmits and receives signals (audio, light, radio, electromagnetic, magnetic, ultrasound, mechanical, chemical, physical (liquid drops etc.) from other units y10′ and computes the relative location based on: the time delay of transmission, reception, Doppler effect, directional scanning, range, intensity or any combination thereof.

FIG. Y2 shows the elements of single unit having a ID code y18, a computer y20, a transceiver y12, and optionally a beacon y14 and scanner y16. Power supplies and other common elements are omitted. The beacon may be omnidirectional. The scanner may be optical, electromagnetic, acousto, physical, or other means, and may be transmissive as well as receptive. Rotating, interference or phase-array scanning is well known.

In a preferred operation, unit y10 will transmit signal with its ID y18 from its transceiver y12 and listen for a response. In the acoustic embodiment, the time delay between transmission and reception is recorded and placed in a table. At an interval, the unit y10 will request the list of ID units and distance/direction from each of the adjacent units y10′ . . . . The computer will then compute by triangulation and other known algorithms, the distance and direction of its local environment. It may transmit this information to a global transreceiver y100 which may control all the units y10 by ID, location or proximity. Communication may also be throughout the network, and each unit y10 may hold a map of the entire organism.

Signals controlling movement if enabled, light, sound, smell and other effects may be employed. This method may be applied to other fields in addition to special effects, including but not limited to industry and defense.

As is shown in recently issued US Patent related to autostereoscopic wands, the autostereoscopic effects module or wand may employed a multiplicity of technologies. All of the embodiments shown therein may be incorporated in the present application.

Section III

1) FIG. 1 shows a front view of a single column of generalized ‘persistence of vision’ display.

2) FIG. 2 shows a top view of a single column of autostereoscopic persistence of vision display.

3) FIG. 3 shows a top view of a single column of autostereoscopic persistence of vision display having a scanned array.

4) FIG. 4 shows a top view of a single column of autostereoscopic persistence of vision display having a static scanning multiplier for a scanned array.

5) FIG. 5 shows a top view of an autostereoscopic display having a multiple view aperture projection.

6) FIG. 6 shows a side view of a persistence of vision display applied to handheld spinner device.

7) FIG. 6A shows a perspective view of a two point, timing and orientation structure for a spinner column display.

8) FIG. 6B shows a top view of a two point, orientation pivot of a spinner display having two or more conductive regions.

9) FIG. 6c shows a top view of a three contact, orientation pivot embodiment.

10) FIG. 6d shows a top view of a slot construction pivot embodiment.

11) FIG. 6e shows a side view of a multiple contact pivot having a axial construction.

12) FIG. 7 shows a side view of a hinged arm embodiment of a persistence of vision display.

13) FIG. 7A shows a side view of an alternative embodiment of a hinged arm, persistence of vision display.

14) FIG. 7B shows a side view of another alternative embodiment of a hinged arm, persistence of vision display.

15) FIG. 8 shows a side and top view of a cylindrical scanning mechanism for a persistence of vision display.

16) FIG. 9A-C shows views of a programmed image of the present invention.

17) FIG. 9C shows a perspective view of a wand based structure

18) FIG. 10 shows a perspective view of the invention applied to a theater presentation.

19) FIG. 11 shows a perspective view of the invention applied to banner.

20) FIG. S1-5 show a medallion embodiment of the present invention

21) FIGS. H1-6 show a retinal projection display embodiment of the present invention

22) FIGS. L1-3 show a robot luminaire projection display embodiment of the present invention

23) FIG. T1 shows a OCT probe embodiment of the present invention;

24) FIG. Y1 shows a movable panel embodiment of the present invention;

25) FIG. Z1 shows an integrated robot embodiment of the present invention.

### DETAILED DESCRIPTION OF THE INVENTION

FIG. 1 shows a front view of a single column of presence of vision display having a representative construction using strobed column 2 of light emitting sources such as shutters or light emitting elements such light emitting diodes (LEDs) 4, 4′, 4″ controlled by a microcomputer 6 (power supply not shown) and displaced cyclically perpendicular to the axis of the column 2 by an electronic actuator 8. When the overall rate of cyclical strobing 10 of the LEDs is approximately greater than 4 Hz, the human eye integrates the strobed columns 2 into an image 12.

The display may be programmable having a communication device such as RF, infrared, BlueTooth, etc. connected to the microcomputer 6 or one or more physical or remote (magnetic, IR, RF, acoustic) button inputs. A coding system with one or more buttons 6A may include the Morse Code, hexadecimal or other known communication protocol. For example, holding the button 6A closed for 3 seconds would cause the microcomputer 6 to enter the record mode indicated by flashing one LED 4. The microcomputer would look for a Morse Code timed input and record the corresponding letters or numbers in the memory. A second 3 second press would exit the record mode, and cause the display to function.

FIG. 2 shows a top view of a single column of autostereoscopic persistence of vision display having a representative construction using strobed two dimensional array of columns 2, 2′, 2″ of light emitting sources such as LEDs 4 controlled by a microcomputer, having an aperture or lens 14 to direct the output of each column 2 to a respective eye 16, 16′ of the observer so as to permit a different image to be observed by each eye. The display unit 20 may be displaced cyclically perpendicular to the axis of the column 2 by an electronic actuator 8. When the overall rate of cyclical strobing of the image 12 is approximately greater than 4 Hz, the human eye integrates the strobed columns 2 into an image 12. Each column may be strobed at rates over 1 MHz, creating an image whose resolution is at least equal to the number of LEDs times the number of columns uniquely strobed. Complex scanning patterns including spaced interlacing permit greater resolutions.

The display unit may operated in a static mode relying on the saccadic motion of the observers' eyes to create a three dimensional image. The saccadic motion may be enhanced by attention strobes 22, 22′ which cause the observers' gaze 24 to move across the display unit interval strobing. In operation, the attention strobe 22 is brightly illuminated, and simultaneously extinguished as the opposite strobe 22′ is illuminated. The observers' gaze 24′ will shift from 22 to 22′ slowly faded. During this interval, the display unit columns 2 are strobed with the image 12. The image may reverse with the direction of the gaze.

It may be noted that the display unit may incorporated global orientation detectors including but not limited to GPS, magnetic compass and field, insolation, inertial, or relative detectors for acceleration, velocity, orientation, insolation, change of direction in order to properly adjust the rate of display and orientation.

FIG. 3 shows a top view of a single column of autostereoscopic persistence of vision display having a representative construction using virtual two dimensional array of strobed columns 2 of light emitting sources such as diodes (LEDs) 4 controlled by a microcomputer 6, scanned about the column aperture by scanning mirror/prism/optical element 12 at a rate equal to the number of autostereoscopic views 12, 12v, 12v′ times the image cycle rate, and displaced cyclically perpendicular to the axis of the column 2, where the virtual displacement of the column is the result of the saccadic motion of human eye 18, 18′.

When the overall rate of cyclical strobing of the LEDs 10 is approximately greater than 8 Hz, the human eye integrates the strobed columns 2 into an image 12I.

FIG. 4 shows a top view of a dynamic column display having a reflector static scan multiplier 32 causing the displacement of the output of column 2 to create a multiplicity of images on the transmissive screen 36 viewable as a image view 12v through aperture/lens 14 where the observed displacement of the column is the result of the relative motion of the frames of reference between the observer and the column. This improvement may be applied to saccadic or moving displays 20.

FIG. 5 shows a top view of a dynamic column display having a transmissive static scan multiplier 32 with the aperture/ens 14 removing creating an autostereoscopic image to the observer 18 with each element of transmissive static scan multiplier 34 creates micro image and the transmissive screen 36′ functions as a focusing virtual window.

FIG. 6 shows a side view of the spinner embodiment of the present invention where the display column 2 is spun about handle 10 connected by pivot 46 and two arms 40, 42. The ‘Bell’, ‘Berlin’ and other patents describe the inherent or index timing sequences of emitters 4-4″ to produce a cylindrical image. The improvements of the present invention may be applied to cylindrical or autostereoscopic image spinners. The present invention may be applied to any spinning configuration including vertical, horizontal, angular connected to the handle by one or arms 40 of either rigid, elastic or string material. A relative position index reference between the handle 10 and the column 2 may be provided. Mechanisms previously employed or disclosed include cam actuated, optical, proximity and magnetic switches as well as orientation sensors based in magnetic field, visible or non-visible (infrared, IV) insolation either ambient or directed, and acoustic including ultrasonic.

FIG. 6A shows a top view of a two point, orientation pivot of a spinner display having two conducting arms 50, 52 which sufficiently enclose the handle 10 to provide a secure pivot 46. The arms 50, 52 may be connected by a non-conducting material 60. In operation, the centrifugal force of revolution will cause the two conducting arms 50, 52 to maintain constant contact with the handle 10 and during at least one period of the revolution to close a circuit through one or more conductive regions 54 of the handle 10. The diameter of the handle may decrease forming a bi-conical neck at the favorable point of rotation. The closure may be used to initiate or orient the display image as well as adjust the timing. The details of the indexing and adjustment have been well known in the field since the publication of the ‘Berlin’ patent in 1979. One computer program method employs a target or starting rotation period value and a correction register holding the measured amount above or below the target value. The sum of the two is used to adjust the column timing parameters including the display on and inter-column period. The correction register may maintain a moving average of several rotations and be compared against a maximum change per period value. The concepts, methods and programming of timing registers are well known in motion control and encoder science.

FIG. 6B shows a top view of a two point, orientation pivot of a spinner display having two or more conductive regions 54, 58 of different closure length, eccentrically placed such that the constant angular velocity of rotation of the pivot 46 about the handle 10 causes a significant timing difference between the sequential circuit closures, 54 and 54-58. In operation, the computer 6 compares the period of closure between the two closures. In the specific example, if the long closure 54 is quickly followed by a short closure 58 and a long open period, then the rotation is counterclockwise from 54 to 58. If the long closure 54 is followed by a long open period, then the rotation is clockwise.

FIG. 6c shows a top view of a three contact, 50, 52, 70 orientation pivot 46. In operation, the sequence of closure, 52-70 or 70-50 followed by a long open period is used to determine direction.

FIG. 6d shows a top view of multiple contact orientation pivot 46 having a slot construction 72 in pivot 46 with raised ridges 74 contacting the upper and lower surfaces of handle 10. This construction provides an economical and secure construction with a reduced bearing surface.

FIG. 6e shows a side view of a multiple contact orientation pivot 46 having a axial construction of contacts 50, 52 movably affixed to pivot arm 46 by pin 76. Vertical conductive regions 54 and 58 are shown.

FIG. 7 shows a side view of the folded spinner type display of the present invention where arms 40 and 42 connecting the handle 10 to the display column 2 as folded at hinges 44, 44′ and 44″. The hinges 44 may be of any material or construction including spring loaded hinges or elastic polymers (elastomers). Expansion may be restorative, centrifugal or manual.

FIG. 7a shows a side view of an alternative construction having a single arm 40 and two hinges 44, 44′. The angular movement between the arm 40 and the display column 2 may be limited by a restraining arm 46 or other known device. Expansion may be restorative, centrifugal or manual. The center of gravity of the display column 2 may be displaced from the hinge 44″ permitting centrifugal stabilization when in motion.

FIG. 7B shows a side view of another alternative construction having a two arms 40, 42 and four hinges 44-44′″.

FIG. 8 shows two views of the cylindrical reflective scanning device employed by the present invention. In operation, an image projected 18 by one or more light emitters shown as a one-dimensional column array 2 is reflected 18′ by a non-uniform scanning cylindrical reflective optic 52, which rotates about axis 58, to a field-correcting optic 54 for which the scanned image beam 18″ is reflected. If the angular change between the reflecting surface of the cylindrical reflector 52 and the axis of rotation 58 is constant, then a constant angular velocity will result in a constant rate of angular scanning of the image beam 18″. An optical or other known encoder 56 may be incorporated which sends a signal to image computer 6. The details of image creation and emitter control by the computer 6 are well known.

It may be noted that the scanning optic 52 and the field optic 54 may be transmissive glass or polymer, as well as but not limited to holographic optical elements (HOE) such as used in bar code scanning. Time sequential color schemes may be employed in uncorrected chromatic systems.

FIG. 9 shows a top view of the active control of the principal view axis 18 of the autostereoscopic view where the image displayed by the principle emitter column 2 to the left eye 16 of the observer shifts to maintain constant direct projection 18′ as the display 20 is translocated to position 20′. This may be accomplished by any known means including the physical rotation of the display 20 including but not limited to a base motor 60 acting on the entire display 20 or the emitter column(s) 2, the physical or virtual movement of the columns 2, 2′ within the display, the physical or virtual translocation of the aperture/lens 14. The change in view axis 18 orientation may be controlled by fixed timing, active timing determined by the velocity or position of the display 20, or tracking of the direction of the principal observer 16. The computer 6 may integrate known sensors for acceleration, velocity, tracking or global orientation. Known sensors include methods for measuring absolute or relative position such as index timing, air speed, GPS, ultrasound, infrared or strobe beams, inertial movement, ambient magnetic field, insolation, etc. The cycle of displacement 20-20′ may repeat regularly, determined by the unity of a formula which compares the distance traveled with the segment length calculated by the number of projected views 2L′-2R′ multiplied times the intra-ocular distance of approximately two inches (2″). This method reduces the number of discrete column views 2, 2′ which are required to insure a complete image to a defined group of observers.

In a stationary saccadic autostereoscopy display where the display 20 remain stationary, the shift in the principle emitter column 2 may be over a fixed period, or may be responsive to the tracking 16T of one or more observers. The tracking mechanism may included a camera 16T, eye tracker or other known device to identify and track individuals and their direction of vision. Direction induction by peripheral strobes 22, 22′ may be employed to coordinated the observer's gaze with the sequence of images.

FIG. 9A shows a top view of a cam-actuated structure to periodically shift the principal view axis 18 by shifting the display 20. In operation, the cam 96 affixed to the handle 10 acts on the actuator rod 92 as the arm 40 rotates causing the actuator rod gear 90′ to interact with the display gear 90 effecting a shift in the orientation of the display 20 and aperture/lens 14. The guides 98 and spring 94 for the actuator rod, although well known for cam structures, are shown.

FIG. 9B shows a top view of a belt-actuated structure where a belt 80 held in place by friction or gearing to the handle 10 acts upon the display unit 20 rotatable about axis 82 causing a shift in the orientation of the principal axis through aperture/lens 14.

FIG. 9C shows a perspective view of a wand based structure where the display 20 is driven by a motor 102 affixed to a base 60. The periodic displacement of the principal axis 18 may be caused by the virtual shift or physically within the display unit 20 are mentioned in FIG. 9. Alternatively, an actuator 104 connected to a integrated or synchronized motion computer 6 may cause the supporting structure 106 to periodically rotate. The actuator may be a rigid or elastic arm, a electromechanical, piezo, piston, pneumatic, hydraulic or other active arm, a magnetic field, or other known method to periodically displace or rotate an arm.

FIG. 10 shows a perspective of the present invention applied to my co-pending applications for stadium effects where a multiplicity of displays 120, 120′, including sound, scent, motion, and texture are controlled by a remote controller 122 through RF, acoustic, or photonic transmissions. The remote controller may assign each display a unique identity based on its location 124, 124′, or the displays may be coded during manufacture or distribution. Global commands could initiate a transmitted or preprogrammed sequence.

FIG. 11 shows a perspective of the present invention applied to my co-pending applications for banners and wands where the banner 130 is affixed to a display unit 20 or 20′ displaceable about handle 10. In stationary operation, the display unit 20 functions as a saccadic unit presenting one or more views through aperture/lens 14 and/or 14′. When the banner is waved a sensor switch 132 in registration with the banner, either affixed or movable, records the initiation and continuity of the motion. The switch 132 may be of any known type and may be place in any position to act in a forward or rearward manner. The sensor switch 132 may be a simple on-off contact or pressure/strain/displacement element capable of an analog or digital scale. The signal is used to adjust the timing by measuring the initiation of a cycle and its duration. Angular displacement may be measured by the same or separate sensor such as the multiple contact units 50, 52 previously described. The microcomputer 6 may contain a communication element for remote control of the image.

FIG. S1 shows a block diagram of the principal components of the flexible embodiment invention having a power supply N6; a microprocessor 6; one or more light modulating elements (LME) 4,4′,4″; a effects component, such as but not limited to speaker, microphone, tactile, scent or other effector; a positional sensor N2, such as but not limited to inertia, gravitational, magnetic, RF, insolation, directional audio sensors; an attachment element N8 such as but not limited to a grommet, button, snap, Velcro, or ties and a communications link N6, such as but not limited to an acoustic, RF, light, IR, or UV link.

In operation, the an image or pattern is display on the LMEs 4,4′ . . . under the control of the microprocessor 6, which operates either from an internal program or in response to commands sent through communications link N6.

The microprocessor 6 may be programmed by one or more switches 6A, 6A′, 6A″ which may be contact, point, magnetic, acoustic, IR or other type. Alphanumeric data may be entered in the Morse or other code.

FIG. S2 shows a medallion and strap embodiment of the present invention which may incorporate all or some of the sensor elements of FIG. S1 not shown. The medallion shape N10 may be attached to a substrate which may include a strap N14 having an attachment element N8 or to any other substrate by any means including but not limited to glue, adhesive tape, snaps, Velcro, hooks, buckles, clasps, rings etc.

The orientation sensor N4 may switch the display to one or more of the LME arrays 4, 4A, 4B, to provide a more vertical display line and thus a more horizontal image. Other orientations and pattern may also be employed.

The medallion embodiment N10 may be orientated with the LME line on the diagonal and display the same pattern regardless of orientation.

The display timing may be fixed or through its sensors N4, N8, N8′ increase or decrease in response to the medallion motion, the user's condition—temperature, pulse, moisture, conductivity, heart rate, or though pattern, or to other external environment or external commands.

FIG. S3 shows the indicator arrangement in the form of the standard watch where LME H1-H12 represents the hours and M1-M12 represent the minutes. It may be understood from The method of displaying the intra-indicator time may be incorporate the pattern where the LMEs representing the hour and the minute are illuminated. When the number of LMEs corresponding to hours or minutes are less than 12 and 60 respectively, then the next lowest LME may be illuminated and the next highest LME may be intermittently pulsed representing the time in excess of the next lowest. For example, if it is 3:12, then the hour LME at 90 degrees clockwise from the top and the minute LME at 60 degrees would be illuminated, plus the minute LME at 90 degrees would pulse twice followed by a separating pause.

The present invention may incorporate all of the autostereoscopic features of the my issued and pending U.S. and other patents and application, incorporated in their entirety herein, including but not limited U.S. Pat. No. 6,404,409.

FIG. S4 shows the medallion and strap embodiment N10 of the present invention incorporating an autostereoscopic LME 4AS on a diagonal having a autostereoscopic or integral photography lens array N16 and corresponding LME N18. Other elements are described in FIG. S1.

The positional and orientation sensors N2, N4 may operate cooperatively with the sensor providing a 6 axis and inertial motion sensing. In operation, if the medallion N10 is affixed to a person's arm while marching sensors N2, N4 will recognize the orientation and adjust the image accordingly. Similarly if the medallion N10 is affixed to a person's arm and waving above one's head, the image will be inverted. If the medallion N10 is affixed to a spinner wand, the sensors N2, N4 will detect the orientation and motion and adjust the image and timing appropriately.

Orientation, motion, position and inertial sensors are well known and include but are not limited to inertial, Doppler, pendulum, moving contact, conductive, air speed, MEMS, and MOEMS constructions.

Autostereoscopic displays function by directing the individual output of each LME of the LME array N18 through the lens N16 to the different eyes of the observer resulting in binocular image disparity. The effect causes the image to appear 3D—and may be designed to appear in front of or behind the actual position of the medallion N10.

FIG. S5 shows the medallion embodiment N10 in a spinner configuration where the motion and relative position sensor N2″, N4 is a Hall-effect, field coil or other magnetic field sensing device affixed to the moving medallion embodiment N10 and the magnet N2′ is positioned approximately axially with the central axis having the N-S pole principal vector being generally parallel to the plane of rotation of the medallion N10. This embodiment provides improved sensor sensitivity, and low cost of components and manufacture.

FIG. L1 shows a preferred embodiment of the present invention in combination with the improved light and communication luminaires described in part in my U.S. Pat. No. 6,404,409 and previous patents where the luminaires N100, N100′, N100″ may be capable of emitting visible or invisible radiation (IR, V, etc) to create visual scenes and communicate data, using methods described in my co-pending applications, to the sensors on the medallions N10, N10′, affixed to the stage, hall, props, scenery, actors or audience. The luminaires N100 may be capable of directing the beam N110 . . . to a sensor-emitter N112 and to a central console computer N120. Additionally the luminaire may have an internal sensor or camera to receive and process images and data. Generally, each luminaire N100 has an internal computer which receives data and instructions via wire, fiber or wireless communication. A central command may be sent from computer N120 to each luminaire N100 . . . to orient itself relative to the sensor N112. If the luminaire has an internal receiver N116 such as a photocell or camera, it may then independently scan until it receives a signal N114 from sensor-emitter N112. Alternatively, the luminaire N100 may project a beam N110 and scan until a signal is receive from sensor-emitter N112. The luminaire N100 and console computer N120 may store the data coordinates generated by the scanning of the luminaire N100. Multiple sensors N112′, N112″ allow full triangulation of the position and orientation of each luminaire N100. Alternatively, multiple receivers or a camera N116 in the luminaire N100 permit triangulation by orientation the different known positions.

FIG. L2 shows the projection of a pattern N118 from the luminaire N100. With the position and orientation of both the stage N130 and the hall N132, the computer may automatically calculate the necessary transformation of the pattern M118′,″,′″ to maintain scale, direction, brightness or other quality.

FIG. L3 shows the chromatic control and resolution multiplier projection of the present invention. The present invention permits the projection of a precise image during the rapid scan of the beam of the luminaire N100. The light source is divided into the constituent colors pixel N122 which may be red, green, and blue (RGB); cyan, magenta, yellow, white (CMYK), or additional combinations (deep green, purple, etc.). The chromatic division may prismatic, dichroic, filters, or other known means including but not limited to methods developed by Phillips Corporation for highly efficient, DMD shutter technology.

Each color pixel N122 is associated with a shutter N124 which may be digital or analog, controlling the output of the pixel.

The pixels N122, N122′, N122″ may be grouped and N130 mixed into white or other color superpixels N126 which have the same cross section as the combination of pixels N122, or a different cross-section N126′ leaving black space N128 between the superpixels N126. The grouper-mixer N130 may be switch between the two states N126, N126′.

A resolution multiple N132 shown in the form of an optical wedge may be cyclically moved to integrated the narrow superpixels N126; into a higher resolution image.

In operation, a stationary luminaire N100 may project an image of the full superpixels N126 onto the stage or hall. The resolution will either be the number of pixels N122 divided by the number of colors, usually three. The pixel period is defined as the time required to present the correct color and intensity for each pixel. High speed shutters such as the DMD (10 KHz) and FLCOS (5 KHz) would allow the pixel period for a binary 3 bit color to be 100 microseconds and 200 microseconds, respectively. The human eye integrates images at approximately 30 Hz. Therefore, movement at rates of 300 pixels per second would elongate the pixel in the direction of motion only twice, permitting detailed control over the scanned images. Higher modulation frequencies, such as source light pixel LEDs, would permit even faster rates.

However, the resolution will be reduced in DMD and FLCOS systems by the superpixel structure. The present invention introduces a resolution multiplier N132, which may be but is not limited to an optical wedge, acousto-optic, electro-optic, HOE or other element, to quickly and cyclically displaced the narrow superpixel N126′ structure to produce a higher resolution. This is particular effective when the beam is moving at rates less than maximum defined speed.

FIG. H1 shows the present invention may also be miniaturized to the medallion and used to project an image to an observer N200. The element may also be used in full size and reflected off a large screen, either HOE or reflective, and incorporates by reference my co-pending applications related to variable-focal length displays in their entirety. In operation, a surface array N210 is positioned co-axially with the view of the observer N200 such that the individual illuminated regions or pixels N212, N212′, N212″ are arranged at different focal distances from the observer N200. Principal optics N214, either transmissive or reflective, may conform the displayed image to the desired focal range. In a two-dimensional surface array N210, an orthogonal scanner N216 at visual integration rates (>30 Hz) may be used to create a full three dimensional image. The pixels N212 of the surface array N210 are controlled by a computer (not shown) and coordinated with the scanner N216 in a manner which permits a full volume to be sequentially displayed. The surface array N210 may be encased in a transparent medium having a constant or variable index of refraction (a GRIN lens).

If an active-matrix architecture is used, where all the pixels may be activated simultaneously, the improvement of this invention may be employed causing multiple pixels on the same optical axis but of different focal distances to be simultaneously illuminated. This method reduces the temporal conditioning of the visual response. FLCOS, DMD are two of the many architectures which employ an active matrix architecture.

FIG. H2 shows the elements of the present invention of FIG. H1 where the divisions of the pixel elements N212 (of surface array N210) perpendicular to the principal axis to the observer N200 have an optical barrier N220 which prevents the light generated by pixel N212 from illuminating adjacent pixels N212′.

FIG. H3A shows an alternative embodiment of the present invention having a surface array N210 arranged orthogonally to the principal axis N222 to the observer N200, and dynamic focusing elements N224 shown activated by piezo-electric actuators. N226, N226′. An augmented reality beam splitter N228 is shown permitting the combination of an external scene N230 with that generated by the pixels N212 of the surface array N210.

FIG. H3B shows front and side view of the focusing element N224 on the actuator N226, N226′. It may be understood that any method of focusing element may be employed including but not limited to liquid crystals, piezo-optic, diffractive, refractive, optical modulators, deformable mirrors and lenses.

FIG. H4 shows a preferred embodiment of the present invention where an aperture shape control element N232 is positioned at the virtual pixel focal point. The aperture element N232 adjusts the diameter and eccentricity of the pixel to proper size and shape for the designated focal distance. A transmissive or reflective optical field of view element N234 is shown. Output form one or more light pixels N212 shown as but not limited to RGB LEDs is mixed in one or more fiber optics N212a and exits through one or more aperture shape control element N232 where the output is scanned by one or two axis scanner N216 (one axis if the array of pixels N212 creates a full row or column of the image). The output reflects for the field element N234 and is focused by focusing optic N224 before being presented to the observer N200.

FIG. H5 shows a top view of another preferred embodiment where the surface array N210 is aligned obliquely to the principal axis to the observer N200 and where the output is scanned by scanner N216-B in one or more axis depending on the organization of the surface array N210. The principal optics N214 are designed to compress the proximal-distal pixels of the array N210 to appear as focusing from the design close focal distance (˜6 inches/15 cm) to infinity (>100 ft.). The surface array N210 may be replaced by a diffusive screen (HOE, reflective or transmissive) upon which the pixels are scanned N212, N216-A.

In operation, the proximal pixels N230 (representing a column of pixels) are scanned across the field of view to locations N230′, N230″ creating the proximal visual plane. The distal pixels N232, N232′, N232″ create the distal visual plane. It may be understood that a surface array of 1000×1000 pixels scanned at 30 Hz and modulated at 30 KHz would produce a volume of pixels of the dimensions [1000×1000×1000]. The Z-axis, which may be considered the principal axis to the observer N200 represents 1000 graduation of focal distance.

The timing of the pixel modulation by depth is shifted by a factor proportional to the cosine of the angle of obliqueness. If, for the purpose of illustration, if distal pixel N232′ at time 1, is one pixel modulation period after proximal pixel N230 at time 0, it may be understood that image database may be routinely transformed by the equation which adds the shift factor of obliqueness to the y value (y value is along the scanning axis and dependent on the scanning frequency and time) and places that pixel in the sequential image queue.

Thus, it may be understood that the sequential timing of images is shown at t0, t1, t2 and the relative focal distance by the distance from the observer N200.

FIG. T1 shows an embodiment of the present invention incorporating an OCT probe N300 which may be used as an image generator in the present invention.

The probe N300 is off a general construction reported in Optics Letters, Vol 26, No. 23, Page 1906, FIG. 1A, having an OCT computer unit (not shown) and a probe N300 which includes an optical fiber N302, directing optics, N302′, a prism N304 and an array of one or more liquid crystal cells N310, N310′ which may be constructed a FLCOS with power and control by fine or transparent wires, optical data, etc.

The cells N310 enable the real-time selection and focusing of the probe beam and return signal to differentiate higher diffraction orders, dynamic polarization axis changes, Doppler element differentiation and other optical phenomena used to identify structures of interest.

FIG. Y1 shows an embodiment of the present invention affixed to a sliding bar or panel N400 which maintains its orientation to the supporting substrate N410 by attachment at two places N416, N416′ to a moving cable N412 arranged in an X pattern rotatably on four pulleys N414a-d rotatably affixed to the supporting substrate N410. In operation, any force which tends to twist the sliding panel N400 at Point A N418 relative to the supporting substrate N410 exerts a force on the cable N412 which translates into a counteracting force through Point B N418′ resulting in an equal and opposite force at Point A. A force which acts equally at and perpendicularly to a line between Point A and B results in the parallel displacement of the sliding panel N400. A motor driving one or more pulleys may be used to automate the sliding panel N400. This embodiment may be used to support any object displacement such as wall panels, doors, drawers, screens or tools.

A closing panel N420 is movably affixed to one or more hinges N422 such that the closing panel may act a cabinet door which when open lies flush against supporting substrate N410 and may be moved to close at an angle by hinges N422 structured to act forward of the substrate N410.

FIG. Z1 shows the integration of the present invention having an OCT image project by Luminaire N100 and medallion N10 placed on moving panel N400 moved on Robot N500. The robot N500 has two or more articulated units N502, N502′, N502″, each having a locomotion means N504 such as but not limited to a tread, wheels, claws, etc., which may extend to the front or rear of the units N502, and extend in all directions.

The units N502 are connected by an articulated, telescoping rod N510 having one or more joints N506 proximal to the unit N502 and an intermediate joint N508 connecting the units N502. In operation, the units may lift each other to climb stairs and negotiate uneven environments.

The embodiment of the invention particularly disclosed and described herein above is presented merely as an example of the invention. Other embodiments, forms and modifications of the invention coming within the proper scope and spirit of the appended claims will, of course, readily suggest themselves to those skilled in the art.

1. A projector and wand receiver system comprising:
a) a control board having means to transmit a series of commands to a projector,
b) said projector having means to receive said commands from said control board and having means to project at least one directional signal to at least one of a plurality of wand receivers,
c) said wand receiver having means to receive said signal and emit a designated response.

2. A projector and wand receiver system as specified in claim 1 wherein said wand receiver means for emitting a designated response further includes at least one light and means for powering said light.

3. A projector and wand receiver system as specified in claim 1 wherein said wand receiver means for emitting a designated response further includes at least one audio speaker and means for powering said speaker.

4. A projector and wand receiver system as specified in claim 1 wherein said projector further includes means for scanning all of a plurality of wand receivers within 100 milliseconds.

5. A projector and wand receiver system as specified in claim 1 wherein said projector further includes means for automatic spatial registration.

6. An autostereoscopic performance effects systems comprising:
a) a control board having means to transmit a series of commands to a projector,
b) said projector having means to receive said commands from said control board and having means to project at least one directional signal to at least one of a plurality of wand receivers,
c) said wand receiver having means to receive said signal and emit a designated response
d) said wand displaying a pixel of autostereoscopic pattern.

7. An autostereoscopic performance effects systems in accordance with claim 6 wherein said wand further includes means to shift said autostereoscopic pattern in relation to the orientation of the wand.
